(19) United States
(12) Patent Application Publication
(10) Pub. No.: US 2013/0229646 A1
(43) Pub. Date: Sep. 5, 2013

(54) COMPONENT ANALYZER

(71) Applicant: SEIKO EPSON CORPORATION, Tokyo (JP)

(72) Inventor: Kazunori SAKURAI, Chino (JP)

(73) Assignee: SEIKO EPSON CORPORATION, Tokyo (JP)

(21) Appl. No.: 13/779,016

(22) Filed: Feb. 27, 2013

(30) Foreign Application Priority Data
Mar. 2, 2012 (JP) 2012-047230

(51) Int. Cl. G01J 3/45

(52) U.S. Cl. CPC G01J 3/45
USPC 356/51; 356/454; 356/72

(57) ABSTRACT

A component analyzer includes a casing, a light source unit, a light incident unit guiding light from a test object into the casing, a tunable interference filter extracting light having a predetermined wavelength from the incident light, an imaging unit receiving the extracted light and taking a spectroscopic image, a control unit performing a component analysis of the test object based on the spectroscopic images, and a display displaying a component analysis result. The light incident unit, the imaging unit, and the control unit are provided within the casing. The tunable interference filter includes a fixed substrate having a fixed reflection film and a movable substrate provided to face the fixed substrate and having a movable reflection film opposed to the fixed reflection film across a gap between reflection films, and an electrostatic actuator changing the gap between reflection films.

### BACKGROUND

1. Technical Field

The present invention relates to a component analyzer that takes a spectroscopic image and analyzes a component of a test object from the spectroscopic image.

2. Related Art

Component analyzers that analyze components of objects to be measured are known (for example, see JP-A-2005-292128 and JP-A-2005-127847.

The device disclosed in JP-A-2005-292128 is a calorie measuring device for food. In the device, a food as a test object is mounted on a turning table provided in an enclosed space, light is applied from a light source unit to the food, and the reflected light or transmitted light from the food is received by a light receiving unit. Here, in the light source unit, light applied from a halogen lamp is divided into plural pulsed lights using a light chopper, the divided lights are spectroscopically separated in resolution of 2 nm using an acousto-optic element, and the spectroscopically-separated lights are applied to the food using a reflection mirror. Further, the device performs a component analysis based on the light received by the light receiving unit, and calculates calories.

Further, in the device disclosed in JP-A-2005-127847, a detection head unit is brought into contact with a test object, and light is applied from a projection head provided in the detection head unit to the test object. Further, the light diffused by the test object is transmitted through a light receiving head. The light receiving head receives the spectroscopically-separated lights obtained by guiding the lights into the device using a fiber optic bundle and spectroscopically-separating the lights using a spectroscopic sensor unit. The spectroscopic sensor unit is provided with a continuous variable interference filter (a so-called linear variable filter) provided by ion assisted deposition on the light-exiting side end surface of the fiber optic bundle, and receives the lights spectroscopically-separated by the continuous variable interference filter using a photoelectric conversion element. Furthermore, a component analysis of the test object is performed based on a spectrum of the received lights. That is, the device disclosed in JP-A-2005-127847 performs a component analysis on one point of the test object in contact with the detection head.

In a device performing a component analysis for food or the like as a test object, for example, a compact device that can be easily carried or the like and readily perform component analysis is desired.

On the other hand, in the above described device of JP-A-2005-292128, the acousto-optic element used for the light source unit is large and not suitable for portability. Further, the device performs the component analysis with the test object placed on the turning table within the enclosed space, and there has been a problem that the device is not suitable for size reduction.

The device of JP-A-2005-127847 is smaller than that of JP-A-2005-292128, however, the device has a configuration in which the light is guided from the detection head unit to the spectroscopic sensor unit using the fiber optic bundle. Therefore, it is impossible to downsize the device to, for example, a pocket size or the like that can be easily carried. However, it is necessary to bring the test object into contact with the detection head unit, and, in the case where the test object is a food, for example, there has been a problem that the device is not suitable from a sanitary standpoint and can perform a component analysis of only the contacted part.

### SUMMARY

An advantage of some aspects of the invention is to provide a compact component analyzer having good portability that can perform a component analysis without contact with a test object.

An aspect of the invention is directed to a component analyzer including a casing, a light source unit (e.g., a light source) that is provided within the casing and outputs light to a test object, an incidence system (e.g., a light guide) that guides light reflected by the test object into the casing, a tunable interference filter that is provided within the casing and extracts a light having a predetermined wavelength from the light entering from the incidence system, an imaging unit (e.g., an imager) that is provided within the casing, receives the light extracted by the tunable interference filter, and takes a spectroscopic image, and a control unit (e.g., a controller) that is provided within the casing and performs a component analysis of the test object based on the spectroscopic image, wherein the tunable interference filter is a Fabry-Perot etalon.

In the aspect of the invention, the component analyzer applies light from the light source unit provided within the casing to the test object, and allows the light reflected by the test object from the incidence system to enter using the tunable interference filter within the casing. Further, the light having the predetermined wavelength extracted by the tunable interference filter is received (imaged) by the imaging unit, and the control unit performs the component analysis of the test object based on the spectroscopic image taken in the imaging unit and allows a display unit to display a result thereof.

Here, in the aspect of the invention, the tunable interference filter and the imaging unit are provided within the casing, and light having a specific wavelength is extracted from the incident light by the tunable interference filter. The tunable interference filter includes the Fabry-Perot etalon and extracts light having the predetermined wavelength using multiple interference by two mirrors, and thereby, its thickness dimension may be made vastly smaller. For example, when the wavelength of the extracted light is in a near-infrared range, the gap between mirrors may be set to 2 μm or less, for example, and thickness dimensions of a first substrate and a second substrate can be set to 1 mm or less, for example, in consideration of substrate stiffness. Therefore, compared to a component analyzer using a larger spectroscopic device such as an AOTF (acousto-optical tunable filter) or an LCTF (liquid crystal tunable filter), for example, downsizing can be realized.

Further, in the aspect of the invention, the component analysis is performed based on the taken image (spectroscopic image) of the test object by the control unit. Therefore, the component analysis may be contactlessly performed on the test object, and, even when the test object is a food, for example, there is no sanitary problem and breakage of the test object due to contact or the like is not caused.

In addition, when the component analysis is performed based on the spectroscopic image, not only the component analysis with respect to one predetermined point in the test object but also the component analysis may be performed with respect to the entire range acquired as the spectroscopic image. That is, the component analysis with respect to plural points may be performed from one spectroscopic image. Thereby, an analysis of a component distribution in the test object, a calculation of a component content ratio of the entire test object, or the like may be easily performed, and a more detailed component analysis on the test object may be performed.

In the case where a component analysis with respect to plural points is performed by a device that performs a component analysis on one point of the test object with a detection head brought into contact with the test object, it is necessary to change the contact location of the detection head and measure light intensity in the contact location again, and the analysis becomes complex. On the other hand, in the aspect of the invention, a component analysis on respective points of the test object within the spectroscopic image may be easily performed from one spectroscopic image.

In the component analyzer according to the aspect of the invention, it is preferable that the incidence system includes plural lens groups that form a virtual image of the test object in the imaging unit, and a light incident angle adjustment unit (e.g., adjuster) that limits incident angles of the incident light to a predetermined angle or less.

In the configuration described above, the incident angles of the incident light may be limited to the predetermined angle or less by the lens groups, and additionally, the incident angles are further limited by the light incident angle adjustment unit. In the configuration, in the imaging unit, incidence of the light from the outside of the incident angles is limited, and the light from the respective points of the test object may be suitably made correspond to the respective points (respective pixels) of a virtual image of the test object formed in the imaging unit. That is, the one predetermined point in the spectroscopic image has light intensity corresponding to one corresponding point of the test object, and thus, the control unit may more accurately perform the component analysis based on the light intensity of the respective pixels of the spectroscopic image. Therefore, high-accuracy component analyses may be performed for the component analysis with respect to the predetermined one point of the test object and the component analysis with respect to the entire test object in the taken image.

In the component analyzer according to the aspect of the invention, it is preferable that plural light transmission parts (e.g., transmitters) and plural light blocking parts (e.g., blockers) having predetermined thickness dimensions along a light incident direction orthogonal to a light incident surface of the tunable interference filter are provided, and a viewing angle limiting plate in which the light transmission parts and the light blocking parts are alternately and adjacently arranged is provided within a surface orthogonal to the light incident direction.

A configuration in which telecentric lenses are used as the lens group forming the incidence system and an aperture provided in the focal position of the telecentric lenses is used as the light incident angle adjustment unit may be employed, however, the number of lenses forming the lens groups may be increased. On the other hand, in the case where the component analysis with respect to a predetermined point is performed from the absorption spectrum at the predetermined point within the image, the telecentric lenses may not be necessary. In this case, a configuration in which the incident light is allowed to enter the tunable interference filter using the viewing angle limiting plate in which the light transmission parts and the light blocking parts having the predetermined thickness dimensions are alternately arranged is provided and the light incident angles are limited by the light blocking parts may be employed. In the configuration, compared to the configuration using the telecentric lenses, the component analyzer may be made even thinner and its portability may be improved.

Further, the light from outside of the range of the predetermined incident angle (outside of the incident angle) may be blocked by the light blocking parts, and the respective points (respective pixels) within the spectroscopic image have intensity corresponding to the respective points in the test object like in the above described aspect of the invention. Therefore, the control unit may perform a high-accuracy component analysis with respect to the respective points of the spectroscopic image.

In the component analyzer according to the aspect of the invention, it is preferable that the imaging unit is provided on a light exit surface of the tunable interference filter.

Here, the configuration in which the imaging unit is provided on the light exit surface of the tunable interference filter includes not only a configuration in which the imaging unit is provided directly on the tunable interference filter but also a configuration in which the imaging unit is provided on the tunable interference filter with a substrate therebetween or the like. Such a substrate includes, for example, a substrate for fixing the tunable interference filter, a part of an optical package housing the tunable interference filter, a circuit board for outputting a signal to a gap changing part, or the like may be cited.

In the configuration described above, the imaging unit is provided on the light exit surface of the tunable interference filter, and thus, the tunable interference filter and the imaging unit may be provided closer to each other without limit, and the component analyzer may be made smaller.

In the component analyzer according to the aspect of the invention, it is preferable that the tunable interference filter extracts light having a predetermined wavelength from a visible light range to a near-infrared range (that is, from one or both of a visible light range and a near-infrared range).

In the configuration described above, the tunable interference filter extracts light from the visible light range to the near-infrared light range by changing the gap between the reflection films. In the configuration, a color image (visible light image) and a spectroscopic image of the near-infrared range for the component analysis of the test object may be acquired by one tunable interference filter and the imaging unit, respectively. In this manner, when the color image is acquired, for example, in the case where a display unit (e.g., a display) that displays the taken image is provided in the component analyzer, by displaying the visible image on the display unit, the component test range in the test object may be easily confirmed.

In the component analyzer according to the aspect of the invention, it is preferable that a color imaging unit that is provided within the casing, and receives a light in a visible light range from the light reflected by the test object and takes a color image, an incidence system for color image (e.g., a color image guide) that guides the light to the color imaging unit, and a display unit that displays the color image taken by the color imaging unit.

As in the above described aspect of the invention, the color image and the image of the near-infrared range may be acquired by the imaging unit, however, as shown in the aspect of the invention, the color imaging unit for taking the color image may be separately provided. Also, in this case, by displaying the color image on the display unit, the range in which the component analysis is performed in the test object may be easily confirmed.

In the component analyzer according to the aspect of the invention, it is preferable that the imaging unit has image sensing devices for monochrome imaging.

In the case where the color image is acquired in the imaging unit, it is necessary to provide image sensing devices having color filters of RGB provided with respect to each pixel for the number of pixels, and the size of the image sensing device provided in each pixel becomes smaller. On the other hand, in the configuration in which the color imaging unit is separately provided, it is necessary to acquire only a near-infrared light having a predetermined wavelength in the imaging unit, and thus, one image sensing device may be provided for each pixel. Therefore, compared to the case where three image sensing devices are provided for each pixel, the light receiving surface of the image sensing device may be made larger. Thereby, the detection accuracy of the amount of light may be improved, and the accuracy of the component analysis may be improved.

In the component analyzer according to the aspect of the invention, it is preferable that the light source unit includes plural light sources that output light having different wavelengths, and the control unit turns on the light source that outputs light having a wavelength corresponding to a component to be analyzed.

In the configuration described above, plural types of light sources that output light having wavelengths desired for the component analysis are provided in response to the absorption spectrum of the component to be analyzed. In the configuration, not all of the light sources are turned on, but the light sources can be sequentially turned on in response to the wavelengths desired for the component analysis, and power saving may be realized.

In the component analyzer according to the aspect of the invention, it is preferable that the light source unit includes a visible light source that outputs a visible light.

The visible light source that outputs the visible light is provided as the light source unit, and thus, for example, even when the outside light is weak, the visible light may be applied to the test object by the visible light source and the test object may be easily contained within the image. Further, when a visible image (color image) is taken and displayed on the display unit, a good color image may be taken by applying the visible light to the test object by the visible light source.

In the component analyzer according to the aspect of the invention, it is preferable that the control unit includes a storage part (e.g., memory) that stores correlation data between feature quantities extracted from absorption spectra of components to be analyzed and component content ratios of components to be analyzed, a filter drive part (e.g., a filter) that sets the wavelength of the light to be extracted by the tunable interference filter, and a component analysis part that analyzes a content ratio and a content of the component to be analyzed of the test object based on the amount of light of respective pixels in the spectroscopic image and the correlation data.

In the configuration described above, the control unit controls the gap between reflection films of the tunable interference filter by the filter drive part, and thereby, may extract the light having a specific wavelength desired for the component analysis from the incident light and acquire the spectroscopic image of the specific wavelength by the imaging unit. Further, the component analysis part may easily obtain the content ratio and the content of the component to be analyzed based on the amount of light of the respective pixels in the taken spectroscopic image and the correlation data using a method such as a chemometrics method, for example.

In the component analyzer according to the aspect of the invention, it is preferable that a temperature detection sensor that detects a temperature of the test object is provided, and the control unit includes a correction part (e.g., a corrector) that corrects the absorption spectrum of each component based on the detected temperature.

In the configuration described above, the temperature detection sensor that detects the temperature of the test object is provided, and the correction part of the control unit corrects the absorption spectrum of the component to be analyzed. Generally, the absorption spectrum of each component contained in the test object changes due to the temperature change. For example, even the component having a feature quantity detected at reference temperature T₁ and wavelength λ₁, its absorption spectrum changes at temperature T₂ and the feature quantity may be detected at wavelength λ₂.

In the configuration described above, even when the temperature changes as described above, the absorption spectrum may be corrected and the wavelength at which the feature quantity is detected may be detected. Therefore, the feature quantity necessary for the component analysis is acquired based on the corrected absorption spectrum, and thus, the accurate component analysis may be performed.

In the component analyzer according to the aspect of the invention, it is preferable that the test object is food, and the component analysis part analyzes a content ratio and a content of one component of fat, sugar, protein, and water contained in the test object and calculates the calories of the test object.

In the configuration described above, the component analysis part analyzes the content ratio and the content of one component of fat, sugar, protein, and water in the food. The fat, sugar, protein, and water are components used for calorie calculation in the food. Therefore, by analyzing the content ratios and the contents of the components, the calories of the food may be calculated and the health promotion of the user may be supported.

In the component analyzer according to the aspect of the invention, it is preferable that a mass measurement unit (e.g., a measurer) that measures a mass when the test object is mounted thereon is provided, and the component analysis part analyzes a content of the component to be analyzed in the test object from the content ratio of the component to be analyzed contained in the test object and the measured mass of the test object.

In the configuration described above, the accurate mass of the test object may be measured using the mass measurement unit. Therefore, the accurate contents of the components to be analyzed may be calculated based on the measured mass and the content ratios of the components to be analyzed by the component analysis part. Further, by calculating the contents of fat, sugar, and protein, an accurate calorie content of the food can be calculated.

In the component analyzer according to the aspect of the invention, it is preferable that the control unit includes a mass estimation part (e.g., an estimator) that estimates a volume of the test object from a taken image of the test object, estimates a specific gravity of the test object based on the content ratio with respect to the predetermined component analyzed by the component analysis part, and calculates the mass of the test object from the estimated volume and specific gravity, and the component analysis part calculates a content of the component to be analyzed in the test object from the content ratio of the component to be analyzed contained in the test object and the estimated mass of the test object.

In the configuration described above, the control unit includes the mass estimation part, and the mass estimation part estimates the volume of the test object based on the taken image. For the estimation of the specific gravity, for example, the component content of water is preferably used, and the content of another component may be used for calculation. Further, the mass estimation part calculates the mass of the test object based on the calculated specific gravity and volume.

According to the configuration, an error is produced compared to the mass measured by the above described mass measurement unit, however, a step of mounting the test object on the mass measurement unit or the like is unnecessary, and the content of the component to be analyzed with respect to the test object may be more readily calculated.

In the component analyzer according to the aspect of the invention, it is preferable that the control unit includes a mass estimation part (e.g., an estimator) that estimates a volume of the test object from a taken image of the test object, and calculates the mass of the test object from a preset specific gravity and the estimated volume, and the component analysis part calculates a content of the component to be analyzed in the test object from the content ratio of the component to be analyzed of the test object and the estimated mass of the test object.

Generally, the specific gravities in foods have nearly the same value. Therefore, the approximate mass of the test object may be calculated from the estimated volume and the average specific gravity of the foods. In the configuration described above, the error in mass becomes greater compared to that in the above described aspects of the invention, however, the calorie calculation may be performed by the simpler processing, and the improvement of the processing speed and the reduction of the power consumption due to the processing load may be realized.

In the component analyzer according to the aspect of the invention, it is preferable that the mass estimation part estimates the volume of the test object based on a taken image formed by imaging a reference material having a known size together with the test object.

As a method of estimating the volume of the test object, for example, the distance between the test object and the component analyzer may be acquired by focusing processing performed when the taken image is acquired, and the volume of the test object may be obtained by analyzing the taken image. Further, the volume can be estimated by creating a three-dimensional image based on taken images from two points of view. However, it is not preferable to perform complex image processing in the compact component analyzer with high portability in view of power saving. On the other hand, in the configuration described above, for example, using a taken image having the reference material having known dimensions and area or the like and the test object, the dimension ratio of the test object to the reference material or the like may be easily calculated by simple image recognition, and the volume of the test object may be easily estimated.

### BRIEF DESCRIPTION OF THE DRAWINGS

The invention will be described with reference to the accompanying drawings, wherein like numbers reference like elements.

FIG. 1 is a perspective view showing a front configuration of a component analyzer of a first embodiment according to the invention.

FIG. 2 is a perspective view showing a rear configuration of the component analyzer of the first embodiment.

FIG. 3 is a schematic view showing a sectional configuration of the component analyzer of the first embodiment.

FIG. 4 shows spectroscopic spectra of illumination light output from a light source part of the first embodiment.

FIG. 5 is a plan view showing a schematic configuration of a tunable interference filter of the first embodiment.

FIG. 6 is a sectional view cut along VI-VI line in FIG. 5.

FIG. 7 is a block diagram showing a schematic configuration of the component analyzer of the first embodiment.

FIG. 8 is a flowchart showing a component analysis method using the component analyzer of the first embodiment.

FIG. 9 shows an example of a taken image of a test object displayed on a display.

FIG. 10 shows an absorption spectrum of a designated point in FIG. 9.

FIG. 11 shows a display example of the display showing an analysis result of component content ratios.

FIGS. 12A and 12B show another display example of the display showing an analysis result of a component content ratio.

FIG. 13 shows a display example of the display showing an analysis result of component contents and calories.

FIG. 14 is a schematic view showing a sectional configuration of a component analyzer of the second embodiment.

FIG. 15 is a perspective view showing a schematic configuration of a viewing angle limiting plate.

FIG. 16 is a perspective view showing another example of the viewing angle limiting plate.

FIG. 17 is a perspective view showing yet another example of the viewing angle limiting plate.

FIG. 18 is a perspective view showing a rear schematic configuration of a component analyzer of the fourth embodiment.

### DESCRIPTION OF EXEMPLARY EMBODIMENTS

### First Embodiment

Hereinafter, a component analyzer according to the first embodiment of the invention will be explained with reference to the drawings.

### Schematic Configuration of Component Analyzer

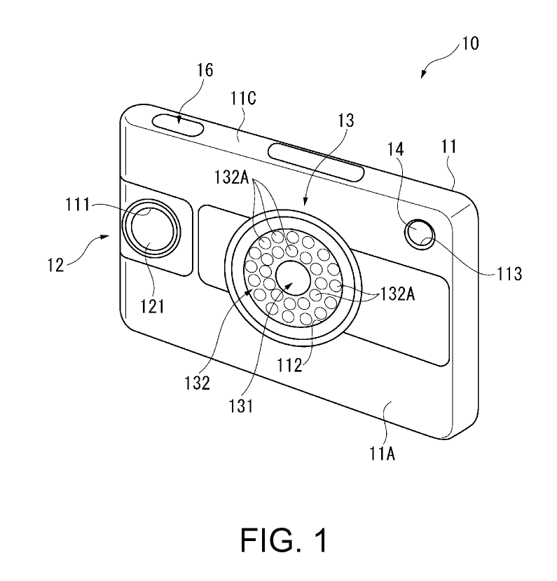

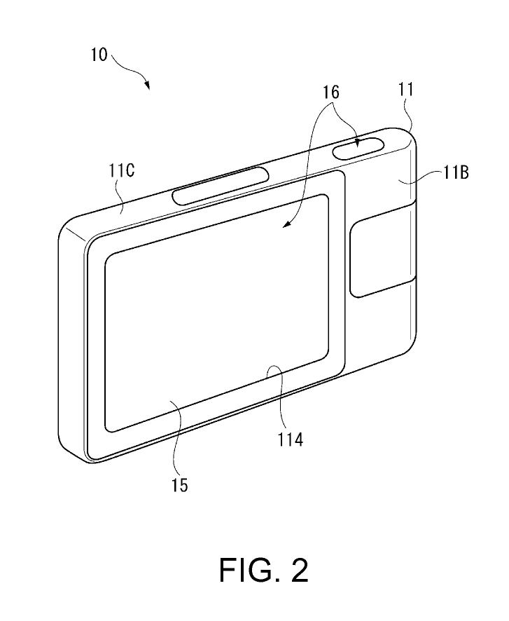

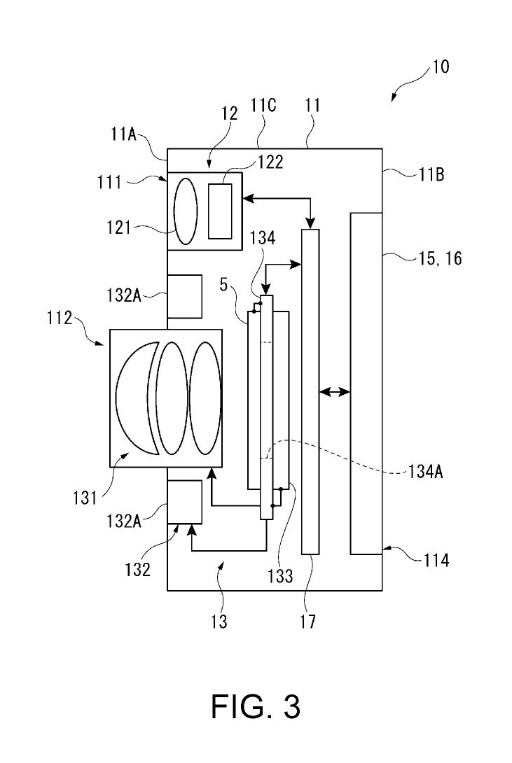

FIG. 1 is a perspective view showing a front configuration of the component analyzer of the first embodiment. FIG. 2 is a perspective view showing a rear configuration of the component analyzer. FIG. 3 is a schematic view showing a sectional configuration of the component analyzer.

As shown in FIGS. 1 to 3, the component analyzer 10 includes a casing 11, a visible light imaging module 12, a near-infrared imaging module 13, a temperature detection sensor 14, a display 15 (display unit), an operation unit 16, and a control unit 17.

### Configuration of Casing 11

The casing 11 has a thickness dimension of about 1 to 2 cm, for example, and is formed in a thin box shape that can be easily put in a pocket of clothing or the like. As shown in FIG. 1, the casing 11 includes a visible imaging window 111 in which the visible light imaging module 12 is provided, a near-infrared imaging window 112 in which the near-infrared imaging module 13 is provided, and a sensor window 113 in which the temperature detection sensor 14 is provided to face a front surface 11A. Further, as shown in FIG. 2, the casing 11 includes a display window 114 in which the display 15 is provided to face a rear surface 11B. Furthermore, the casing 11 includes a shutter button forming the operation unit 16 in a part of a side surface 11C.

### Configuration of Visible Light Imaging Module 12

The visible light imaging module 12 includes a visible light incident part 121 (incidence system for a color image) provided to face the visible imaging window 111 of the casing 11, and a color imaging part 122.

Note that, in FIG. 3, an example in which the visible light incident part 121 includes one lens is shown, however, in practice, the part includes plural lenses and these lenses form a virtual image of a test object in the color imaging part 122.

The color imaging part 122 includes plural image sensing devices. These image sensing devices include an image sensing device for R (red), an image sensing device for G (green), and an image sensing device for B (blue) for each one pixel, for example, and they respectively have color filters (R, G, B) corresponding to colors of light to receive.

Further, the color imaging part 122 outputs color image signals based on the light received by the respective image sensing devices to the control unit 17.

### Configuration of Near-Infrared Imaging Module 13

The near-infrared imaging module 13 includes a light incident part 131 provided to face the near-infrared imaging window 112, a light source part 132 provided to face the near-infrared imaging window 112, a tunable interference filter 5 that the light from the light incident part 131 enters, an imaging part 133 that receives the light extracted by the tunable interference filter 5, and a control board 134.

### Configuration of Light Incident Part 131

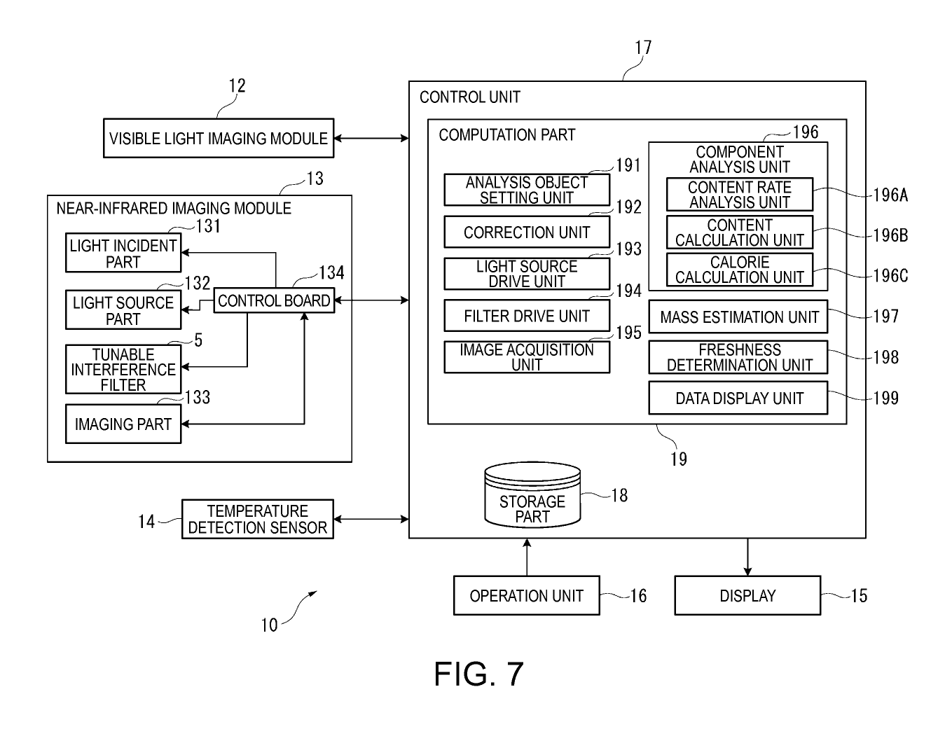

As shown in FIG. 3, the light incident part 131 includes plural lenses and forms an incidence system. In the light incident part 131, a viewing angle is limited to a predetermined angle or less by the plural lenses, and a virtual image of the test object within the viewing angle is formed in the imaging part 133 via the tunable interference filter 5. Further, a distance between some of the plural lenses can be adjusted through operation of the operation unit 16 by a user, for example, and thereby, an image to be acquired can be scaled. In the embodiment, telecentric lenses are preferably used as the lenses forming the light incident part 131. With the telecentric lenses, the optical axes of incident light may be aligned in parallel to a principal ray, and the light can perpendicularly enter a fixed reflection film 54 and a movable reflection film 55 of the tunable interference filter 5, which will be described later. Further, when the telecentric lenses are used as the lenses forming the light incident part 131, an aperture is provided in a focal position of the telecentric lenses. The aperture forms a light incident angle adjusting unit, and the aperture diameter is controlled by the control unit 17 (see FIG. 7), and thereby, the viewing angle can be controlled. Note that the incident angle of the incident light limited by the lens group, the aperture, or the like is different depending on the lens design or the like, and is preferably limited to 20 degrees or less form the optical axis.

### Configuration of Light Source Part 132

As shown in FIGS. 1 and 3, the light source part 132 includes plural light sources 132A (LEDs) annularly arranged along the outer circumference part of the near-infrared imaging window 112. In the embodiment, the LEDs are exemplified as the light sources 132A, however, for example, laser sources or the like may be used. By using the LEDs or laser sources as the light sources 132A, downsizing and power saving of the light source part 132 may be realized.

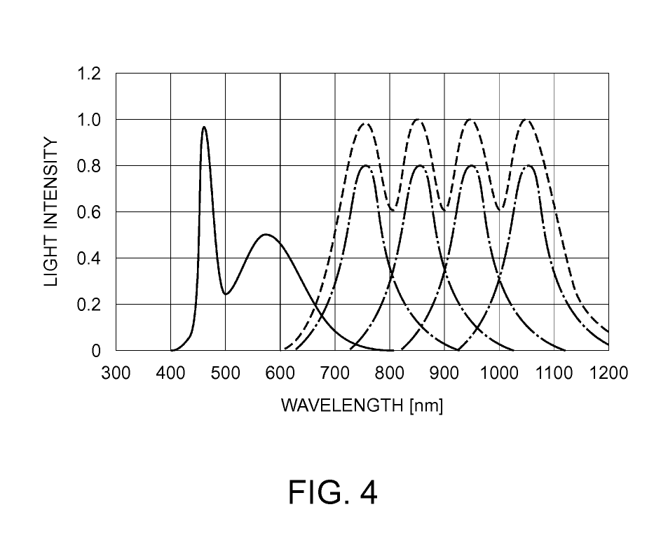

FIG. 4 shows spectroscopic spectra of illumination light output from the light source part 132 of the embodiment.

As shown in FIG. 4, the light source part 132 includes plural types of light sources 132A having different emission wavelengths. Specifically, the part 132 includes a visible light source that outputs a visible light (the light shown by a solid line in FIG. 4), and plural types of near-infrared light sources that output near-infrared light having different emission wavelength bands (the light shown by dashed-dotted lines in FIG. 4).

Here, the plural types of near-infrared light sources respectively have bandwidths of 50 to 100 nm, and can output light having nearly uniform amounts of light with respect to the respective wavelengths in the near-infrared range (the light shown by a broken line in FIG. 4) by combining the light of the near-infrared light sources. Further, in the component analyzer 10 of the embodiment, a component analysis is performed based on a spectroscopic image corresponding to an absorption spectrum of a component as a component analysis object. Here, in the embodiment, the control board 134 turns on the light source 132A of a wavelength corresponding to the absorption spectrum of the component to be analyzed of the light sources 132A and turns off the other light sources 132A. Thereby, power saving may be further promoted and an efficient component analysis may be performed.

Note that the visible light source may include plural types of light sources having different emission wavelength bands.

### Configuration of Tunable Interference Filter 5

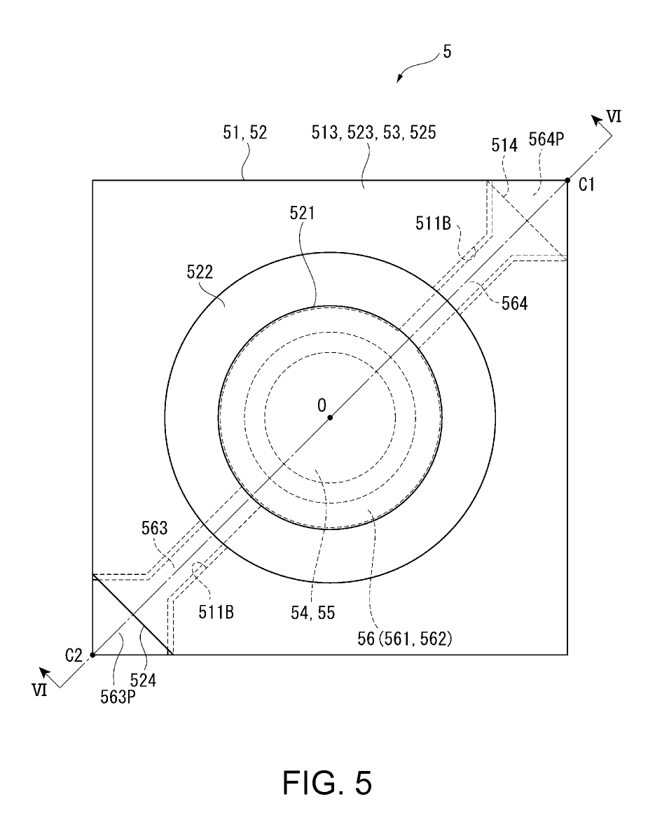

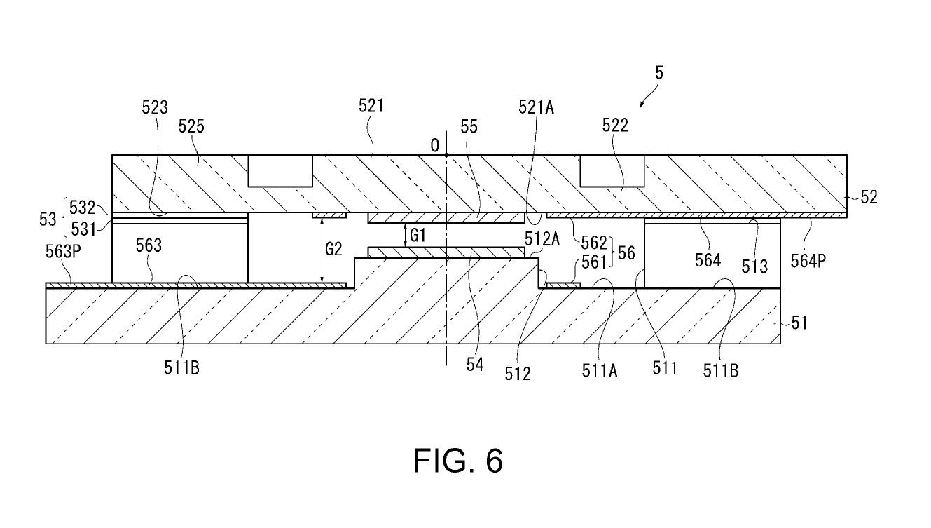

FIG. 5 is a plan view showing a schematic configuration of the tunable interference filter. FIG. 6 is a sectional view of the tunable interference filter cut along VI-VI line in FIG. 5.

The tunable interference filter 5 is a Fabry-Perot etalon. The tunable interference filter 5 is a rectangular plate-like optical member, for example, and includes a fixed substrate 51 formed to have a thickness dimension of about 500 μm, for example, and a movable substrate 52 formed to have a thickness dimension of about 200 μm, for example. The fixed substrate 51 and movable substrate 52 are respectively formed using various kinds of glass of soda glass, crystalline glass, quartz glass, lead glass, potassium glass, borosilicate glass, alkali-free glass, or quartz, for example. The fixed substrate 51 and the movable substrate 52 are integrally formed by bonding of a first bonding part 513 of the fixed substrate 51 and a second bonding part 523 of the movable substrate 52 using bonding films 53 (a first bonding film 531 and a second bonding film 532) including plasma-polymerized films with siloxane as a principal component, for example.

The fixed reflection film 54 is provided on the fixed substrate 51 and the movable reflection film 55 is provided on the movable substrate 52. The fixed reflection film 54 and movable reflection film 55 are oppositely provided across a gap between reflection films G1. Further, an electrostatic actuator 56 used for adjusting (changing) the amount of gap of the gap between reflection films G1 is provided in the tunable interference filter 5. The electrostatic actuator 56 includes a fixed electrode 561 provided on the fixed substrate 51 and a movable electrode 562 provided on the movable substrate 52. These fixed electrode 561 and movable electrode 562 are opposed across a gap between electrodes G2. Here, the fixed electrode 561 and the movable electrode 562 may be provided directly on the substrate surfaces of the fixed substrate 51 and the movable substrate 52, respectively, or provided via other film members. Here, the amount of gap of the gap between electrodes G2 is larger than the amount of gap of the gap between reflection films G1.

Further, in a filter plan view as shown in FIG. 5 in which the tunable interference filter 5 is seen from the substrate thickness direction of the fixed substrate 51 (movable substrate 52), the plane center point O of the fixed substrate 51 and the movable substrate 52 coincides with the center point of the fixed reflection film 54 and the movable reflection film 55, and coincides with the center point of a movable part 521, which will be described later.

Note that, in the following explanation, the plan view as seen from the substrate thickness direction of the fixed substrate 51 or the movable substrate 52, i.e., the plan view of the tunable interference filter 5 as seen from the stacking direction of the fixed substrate 51, the bonding films 53, and the movable substrate 52 is referred to as “filter plan view”.

### Configuration of Fixed Substrate

On the fixed substrate 51, an electrode placement groove 511 and a reflection film provision part 512 are formed by etching. The fixed substrate 51 has a larger thickness dimension than that of the movable substrate 52, and no distortion is produced in the fixed substrate 51 due to electrostatic attractive force when a voltage is applied between the fixed electrode 561 and the movable electrode 562 and internal stress of the fixed electrode 561.

Further, a cutout part 514 is formed at an apex C1 of the fixed substrate 51, and a movable electrode pad 564P to be described later is exposed at the fixed substrate 51 side of the tunable interference filter 5.

The electrode placement groove 511 is annularly formed around the plane center point O of the fixed substrate 51 in the filter plan view. The reflection film provision part 512 is formed to project toward the movable substrate 52 side from the center part of the electrode placement groove 511 in the plan view. The groove bottom surface of the electrode placement groove 511 is an electrode provision surface 511A on which the fixed electrode 561 is provided. Further, the projected end surface of the reflection film provision part 512 is a reflection film provision surface 512A.

Further, on the fixed substrate 51, an electrode extraction groove 511B extending from the electrode placement groove 511 toward the apex C1 and an apex C2 of the outer circumference edge of the fixed substrate 51 is provided.

The fixed electrode 561 is provided on the electrode provision surface 511A of the electrode placement groove 511. More specifically, the fixed electrode 561 is provided in a region opposed to the movable electrode 562 of the movable part 521, which will be described later, of the electrode provision surface 511A. Further, an insulating film for securing insulation between the fixed electrode 561 and the movable electrode 562 may be stacked on the fixed electrode 561.

Further, on the fixed substrate 51, a fixed extraction electrode 563 extending from the outer circumference edge of the fixed electrode 561 in the direction toward the apex C2 is provided. The extending end part (the part located at the apex C2 of the fixed substrate 51) of the fixed extraction electrode 563 forms a fixed electrode pad 563P connected to the control board 134.

Note that, in the embodiment, the configuration in which one fixed electrode 561 is provided on the electrode provision surface 511A is shown, however, for example, a configuration in which two electrodes forming concentric circles around the plane center point O are provided (dual electrode configuration) may be employed.

As described above, the reflection film provision part 512 is formed in a nearly cylindrical shape having a diameter dimension smaller than that of the electrode placement groove 511 coaxially with the electrode placement groove 511, and includes the reflection film provision surface 512A opposed to the movable substrate 52 of the reflection film provision part 512.

As shown in FIG. 6, the fixed reflection film 54 is provided on the reflection film provision part 512. As the fixed reflection film 54, for example, a metal film of Ag, an alloy film of an Ag alloy, or the like may be used. Further, for example, a dielectric multilayer film with a high-refractive-index layer of TiO₂ and a low-refractive-index layer of SiO₂ may be used. Furthermore, a reflection film formed by stacking a metal film (or an alloy film) on the dielectric multilayer film, a reflection film formed by stacking the dielectric multilayer film on a metal film (or an alloy film), a reflection film formed by stacking a single-layer refractive layer (TiO₂, SiO₂, or the like) and a metal film (or an alloy film), or the like may be used.

In addition, an antireflection film may be formed in a location corresponding to the fixed reflection film 54 on the light incident surface (the surface without the fixed reflection film 54) of the fixed substrate 51. The antireflection film may be formed by alternately stacking the low-refractive-index layers and the high-refractive-index layers, and reduces the reflectance and increases the transmittance of the visible light on the surface of the fixed substrate 51.

Further, of the surface of the fixed substrate 51 opposed to the movable substrate 52, the surface without the electrode placement groove 511, the reflection film provision part 512, or the electrode extraction groove 511B formed by etching forms the first bonding part 513. The first bonding film 531 is provided in the first bonding part 513, and the first bonding film 531 is bonded to the second bonding film 532 provided on the movable substrate 52, and thereby, the fixed substrate 51 and the movable substrate 52 are bonded as described above.

### Configuration of Movable Substrate

The movable substrate 52 includes the movable part 521 having a circular shape around the plane center point O, a holding part 522 that is coaxial with the movable part 521 and holds the movable part 521, and a substrate outer circumference part 525 provided outside of the holding part 522 in the filter plan view as shown in FIG. 5.

Further, on the movable substrate 52, a cutout part 524 is formed in correspondence with the apex C2 as shown in FIG. 5, and the fixed electrode pad 563P is exposed as seen from the movable substrate 52 side of the tunable interference filter 5.

The movable part 521 is formed to have a thickness dimension thicker than that of the holding part 522, and, for example, formed to have the same dimension as the thickness dimension of the movable substrate 52. The movable part 521 is formed to have at least a diameter dimension larger than the diameter dimension of the outer circumference edge of the reflection film provision surface 512A in the filter plan view. Further, in the movable part 521, the movable electrode 562 and the movable reflection film 55 are provided.

Note that, like the fixed substrate 51, an antireflection film may be formed on the surface of the movable part 521 opposite to the fixed substrate 51. The antireflection film may be formed by alternately stacking the low-refractive-index layers and the high-refractive-index layers, and may reduce the reflectance and increase the transmittance of the visible light on the surface of the movable substrate 52.

The movable electrode 562 is opposed to the fixed electrode 561 across the gap between electrodes G2, and formed in an annular shape, the same shape as that of the fixed electrode 561. Further, a movable extraction electrode 564 extending from the outer circumference edge of the movable electrode 562 toward the apex C1 of the movable substrate 52 is provided on the movable substrate 52. The extending end part (the part located at the apex C1 of the movable substrate 52) of the movable extraction electrode 564 forms the movable electrode pad 564P connected to the control board 134.

The movable reflection film 55 is provided to be opposed to the fixed reflection film 54 across the gap between reflection films G1 in the center part of a movable surface 521A of the movable part 521. As the movable reflection film 55, a reflection film having the same configuration as that of the above described fixed reflection film 54 is used.

Note that, in the embodiment, as described above, the example in which the amount of gap of the gap between electrodes G2 is larger than the amount of gap of the gap between reflection films G1 is shown, however, it is not limited to that. For example, depending on the wavelength range of light to be measured such that infrared light or far-infrared light is used as the light to be measured, the amount of gap of the gap between reflection films G1 may be larger than the amount of gap of the gap between electrodes G2.

The holding part 522 is a diaphragm surrounding the movable part 521, and formed to have a thickness dimension smaller than that of the movable part 521. The holding part 522 is more flexible than the movable part 521, and the movable part 521 can be displaced toward the fixed substrate 51 side by slight electrostatic attractive force. In this regard, the movable part 521 has a larger thickness dimension and a larger stiffness than those of the holding part 522, and thereby, even when the holding part 522 is pulled toward the fixed substrate 51 side by the electrostatic attractive force, the shape change of the movable part 521 does not occur. Therefore, no deflection of the movable reflection film 55 provided in the movable part 521 is produced, and the fixed reflection film and the movable reflection film 55 may be maintained constantly in the parallel condition.

Note that, in the embodiment, the holding part 522 having the diaphragm shape is exemplified, however, it is not limited to that. For example, a configuration in which beam-like holding parts arranged at equal angle intervals around the plane center point O are provided may be employed.

As described above, the substrate outer circumference part 525 is provided outside of the holding part 522 in the filter plan view. The surface of the substrate outer circumference part 525 opposed to the fixed substrate 51 includes the second bonding part 523 opposed to the first bonding part 513. Further, the second bonding film 532 is provided in the second bonding part 523, the second bonding film 532 is bonded to the first bonding film 531, and thereby, the fixed substrate 51 and the movable substrate 52 are bonded as described above.

### Size and Placement Location of Tunable Interference Filter 5

Further, in the component analyzer 10 of the embodiment, a color image is taken by the visible light imaging module 12. Accordingly, the tunable interference filter 5 is formed to have dimensions that can transmit light in the near-infrared range. Therefore, by setting the gap between reflection films G1 to 1 μm or less, for example, near-infrared light can be extracted as a primary peak wavelength or a secondary peak wavelength. Further, as described above, the thickness dimension of the fixed substrate 51 is formed to be about 500 μm and the thickness dimension of the movable substrate 52 is formed to be about 200 μm. Therefore, the entire thickness dimension of the tunable interference filter 5 may be suppressed to a thickness dimension of 1 mm or less.

Furthermore, in the embodiment, the surface (light exit surface) of the movable substrate 52 opposite to the fixed substrate 51 of the tunable interference filter 5 is fixed to the control board 134 in the substrate outer circumference part 525. The control board 134 has a terminal part to which the fixed electrode pad 563P and the movable electrode pad 564P are connected, and, for example, the respective pads 563P, 564P are connected to the terminal part by FPCs (Flexible printed circuits) or the like. The imaging part 133 is fixed to the opposite surface to the surface of the control board 134 on which the tunable interference filter 5 is provided. Further, the light extracted by multiple interference by the fixed reflection film 54 and the movable reflection film 55 passes through a light passage hole 134A provided on the control board 134 and is received by the imaging part 133, and thereby, a spectroscopic image is taken by the imaging part 133. That is, in the embodiment, the tunable interference filter 5 is attached to one surface of the control board 134 and the imaging part 133 is attached to the other surface of the control board 134, and the tunable interference filter 5 and the imaging part 133 are closely arranged. Thereby, the near-infrared imaging module 13 may be made even thinner, and the component analyzer 10 may be made smaller and thinner.

Note that the configuration in which the tunable interference filter 5 is fixed to the control board 134 has been shown, however, it is not limited to that. For example, a configuration in which the tunable interference filter 5 is housed in a package and the package is fixed to the control board 134 or the like may be employed. Further, a configuration in which the tunable interference filter 5 is fixed to a fixing part provided on a substrate other than the control board 134 or within the casing 11 and the tunable interference filter 5 and the control board 134 are closely provided or the like may be employed.

Furthermore, in the embodiment, the color image is taken by the visible light imaging module 12, and the spectroscopic image in the near-infrared range may be taken in the near-infrared imaging module 13. Therefore, in order to block visible light (and ultraviolet light) transmitted as secondary and subsequent peak wavelengths, for example, of the light transmitted through the tunable interference filter 5, a near-infrared high-pass filter that transmits only the light having the wavelength in the near-infrared range may be provided. The near-infrared high-pass filter may be provided in any location in an optical path of the incident light in the near-infrared imaging module 13, and, for example, locations between the imaging part 133 and the tunable interference filter 5, between the light incident part 131 and the tunable interference filter 5, between the lens groups of the light incident part 131, on the near-infrared imaging window 112 of the component analyzer 10, may be exemplified.

### Configuration of Imaging Part 133

The imaging part 133 includes plural image sensing devices that receive near-infrared light transmitted through the tunable interference filter 5. As the imaging part 133, for example, an image sensor such as a CCD or CMOS may be used. Further, in the embodiment, the color image is taken by the visible light imaging module 12, and it is only necessary for the imaging part 133 to take a monochrome image at a predetermined wavelength in an infrared range and image sensing devices for monochrome imaging are used, one image sensing device for each pixel. In the imaging part 133, for example, compared to the imaging part for color imaging in which it is necessary to provide image sensing devices corresponding to R, G, and B in each pixel, the light receiving surface for one pixel may be made larger and the amount of light of the wavelength to be measured may be received more efficiently. Thereby, the sufficient amount of light for the component analysis may be secured and the spectroscopic accuracy may be improved.

Note that, as described above, in the configuration with the near-infrared high-pass filter provided in the optical path, an image sensor having a sensitivity characteristic for a wide range from the near-infrared range to the visible light range (or the ultraviolet range) may be used as the imaging part 133. On the other hand, in the configuration without the near-infrared high-pass filter, in order not to receive the light in the visible light range or the ultraviolet range transmitted from the tunable interference filter 5 as the secondary peak and the tertiary peak, image sensing devices having a low sensitivity characteristic for the ultraviolet to the visible light range and a high sensitivity characteristic for the near-infrared range such as GaAs photosensors, for example, may be used.

Further, the imaging part 133 outputs an image signal of the spectroscopic image (spectroscopic image signal) based on the light received by the respective image sensing devices to the control unit 17 via the control board 134.

### Configuration of Control Board 134

The control board 134 is a circuit board for controlling the operation of the near-infrared imaging module 13, and connected to the light incident part 131, the light source part 132, the tunable interference filter 5, and the imaging part 133. Further, the control board 134 controls the operations of the respective configurations based on the control signal input from the control unit 17. For example, when a user performs a zoom operation, a predetermined lens of the light incident part 131 is moved or the aperture diameter of the aperture is changed. Further, when an operation of imaging the test object is performed for the component analysis, turning on and off of the respective light sources 132A of the light source part 132 are controlled based on the control signal input from the control unit 17, and a predetermined voltage based on the control signal is applied to the electrostatic actuator 56 of the tunable interference filter 5. Further, the spectroscopic image (spectroscopic image signal) taken by the imaging part 133 is output to the control unit 17.

### Configuration of Temperature Detection Sensor 14

The temperature detection sensor 14 is provided to face the sensor window 113 of the casing 11, and detects the temperature of the test object. As the temperature detection sensor 14, for example, a thermopile array, a non-contact bolometer, or the like may be used.

### Configuration of Display 15

The display 15 is provided to face the display window 114 of the casing 11. As the display 15, any device that can display an image may be used, and, a liquid crystal panel, an organic EL panel, or the like may be exemplified.

Further, the display 15 of the embodiment also serves as a touch panel and also functions as one of the operation unit 16.

### Configuration of Operation Unit 16

As described above, the operation unit 16 includes the shutter button provided on the side surface 11C, and the touch panel provided on the display 15. When the user performs an input operation, the operation unit 16 outputs an operation signal in response to the input operation to the control unit 17. Note that, the operation unit 16 is not limited to the above configuration, but a configuration provided with, for example, plural operation buttons or the like in place of the touch panel may be employed.

### Configuration of Control Unit 17

FIG. 7 is a block diagram showing a schematic configuration of the component analyzer 10.

The control unit 17 is formed by a combination of a CPU and a memory or the like, for example, and controls the entire operation of the component analyzer 10. As shown in FIG. 7, the control unit 17 includes a storage part 18 (storage unit) and a computation part 19.

In the storage part 18, an OS for controlling the entire operation of the component analyzer 10, programs for realizing various functions, and various data are stored. Further, the storage part 18 includes a temporary storage region that temporarily stores acquired spectroscopic images, color images, and component analysis results.

Further, in the storage part 18, various data including V-λ, data representing relationships between drive voltages applied to the electrostatic actuator 56 of the tunable interference filter 5 and wavelengths of light transmitted through the tunable interference filter 5 is stored.

Further, in the storage part 18, correction values for absorption spectra of the respective components with respect to temperatures are stored.

Furthermore, in the storage part 18, correlation data (for example, calibration curves) representing feature quantities (absorbance at specific wavelengths) extracted from the absorption spectra with respect to the respective components to be analyzed and component content ratios are stored.

In addition, in the storage part 18, freshness determination data representing relationships between types of test objects and components used for freshness determination of the test objects are stored.

The computation part 19 reads the programs stored in the storage part 18 and executes various processing, and includes an analysis object setting unit 191, a correction unit 192, a light source drive unit 193, a filter drive unit 194, an image acquisition unit 195, a component analysis unit 196, amass estimation unit 197, a freshness determination unit 198, and a data display unit 199.

The analysis object setting unit 191 sets a component to be analyzed by an operation of the operation unit 16 by the user, for example. Further, when the component to be analyzed is not designated by the user, fat, sugar, protein, and water are set as analysis objects in initial setting. Note that, the components set in the initial setting can be appropriately changed by the operation of the user.

The correction unit 192 corrects the absorption spectrum based on the temperature of the test object detected by the temperature detection sensor 14.

The light source drive unit 193 outputs a control signal for driving the light source part 132 to the control board 134 of the near-infrared imaging module 13.

The filter drive unit 194 sets a drive voltage for setting the wavelength of the light to be extracted by the tunable interference filter 5 based on the V-λ data stored in the storage part 18, and outputs a control signal to the control board 134.

The image acquisition unit 195 acquires a color image taken by the color imaging part 122 of the visible light imaging module 12 at a time when the shutter button of the operation unit 16 is operated by the user. Further, the image acquisition unit 195 sequentially acquires spectroscopic images taken by the imaging part 133 of the near-infrared imaging module 13 from the time when the shutter button of the operation unit 16 is operated by the user.

As shown in FIG. 7, the component analysis unit 196 includes a content ratio analysis unit 196A, a content calculation unit 196B, and a calorie calculation unit 196C.

The content ratio analysis unit 196A calculates absorbance from the amount of light of the respective pixels of the acquired spectroscopic images, and analyzes the content ratios with respect to the respective components using the correlation data stored in the storage part 18.

The content calculation unit 196B calculates contents of the respective components based on the content ratios of the respective components calculated by the content ratio analysis unit 196A and a mass of the test object estimated by the mass estimation unit 197, which will be described later.

The calorie calculation unit 196C calculates the calories of the entire test object based on the contents of the respective components.

The mass estimation unit 197 estimates a volume of the test object based on the taken image and estimates the mass of the test object based on the estimated volume.

The freshness determination unit 198 determines freshness of the test object based on the freshness determination data stored in the storage part 18.

The data display unit 199 allows the display 15 to display the color image and the spectroscopic images acquired by the image acquisition unit 195, an analysis result analyzed by the component analysis unit 196, the volume and the mass estimated by the mass estimation unit 197, and a determination result by the freshness determination unit 198.

Note that the specific processing by the computation part 19 will be described later.

Component Analysis Processing of Test Object using Component Analyzer 10

Next, the component analysis processing using the above described component analyzer 10 will be explained below with reference to the drawings.

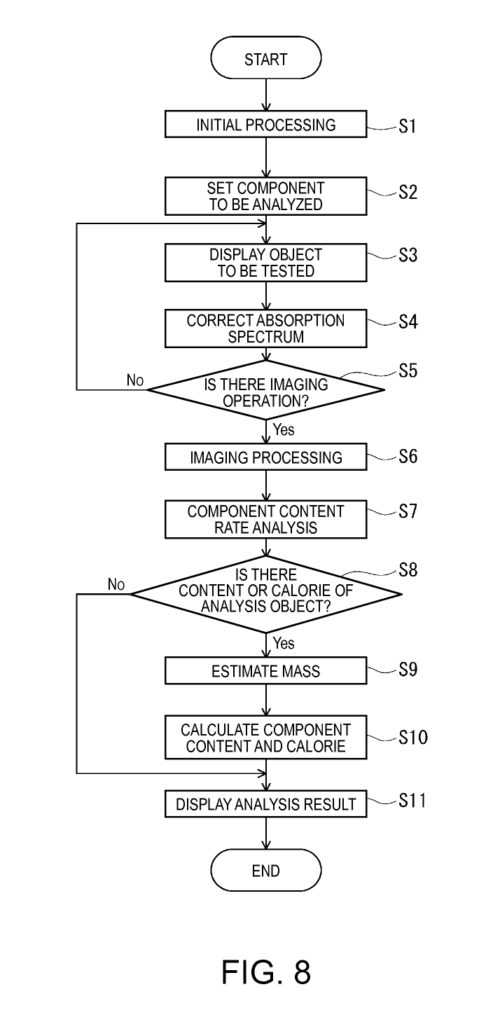

FIG. 8 is a flowchart showing the component analysis processing using the component analyzer 10.

As shown in FIG. 8, when the component analysis processing is performed using the component analyzer 10 of the embodiment, first, initial processing of acquiring a reference amount of received light for calculation of absorbance is performed (S1). At the S1, for example, imaging is performed on a reference calibration plate such as a white plate or the like, and the amounts of received light I₀ at the respective wavelengths are measured. Specifically, the computation part sequentially switches the voltage applied to the electrostatic actuator 56 by the filter drive unit 194, and switches the transmission wavelengths at 10 nm intervals, for example, with respect to a predetermined near-infrared wavelength range (for example, from 700 nm to 1500 nm). Then, the amounts of received light with respect to the respective wavelengths are detected by the imaging part 133 and stored in the storage part 18. Here, the computation part 19 may use the amount of received light of only one point on the reference calibration plate as the reference amount of received light, or may specify the pixel range of the reference calibration plate of the respective spectroscopic images and calculate an average value of the amounts of light in a predetermined number of pixels within the specified pixel ranges or all pixels.

Then, a test object is set as a subject of the component analyzer 10 and performs a component analysis on the test object.

Here, when the calculation of the contents with respect to the respective components of the test object and the calorie calculation are performed, for estimation of the volume of the test object, the test object is mounted on a preset dish having a known size and a component analysis is performed. Note that when the calculation of the contents and the calories is not performed, for example, it is not necessary to estimate the volume of the test object for freshness, sugar, chemicals content ratio of the test object, for example, the object is not necessarily mounted on the dish.

In the component analysis of the test object, the computation part 19 sets the component to be analyzed by the analysis object setting unit 191 (S2).

Specifically, if the component to be analyzed has been set by the operation of the operation unit 16 by the user, the analysis object setting unit 191 sets the set component as the analysis object. Further, if the component to be analyzed has not been set, the unit sets fat, sugar, protein, and water as analysis objects in the initial setting.

Further, at the S2, whether to analyze only the component content ratios of the respective components of the test object or to also analyze the component contents can be selected. When the component contents are analyzed, mass estimation processing by the mass estimation unit 197 is performed, which will be described later.

Furthermore, if a freshness analysis is selected by the operation of the operation unit 16 by the user, the analysis object setting unit 191 allows the display 15 to prompt selection of the type of test object, for example. Then, if the type of test object is selected by the user, the analysis object setting unit 191 sets the component to be analyzed for freshness determination as the component of the analysis object based on the freshness determination data stored in the storage part 18. For example, generally, freshness of fruits and vegetables may be determined by the content of chlorophyll, and freshness of fish may be determined by adenosine 3′-phosphate or the like.

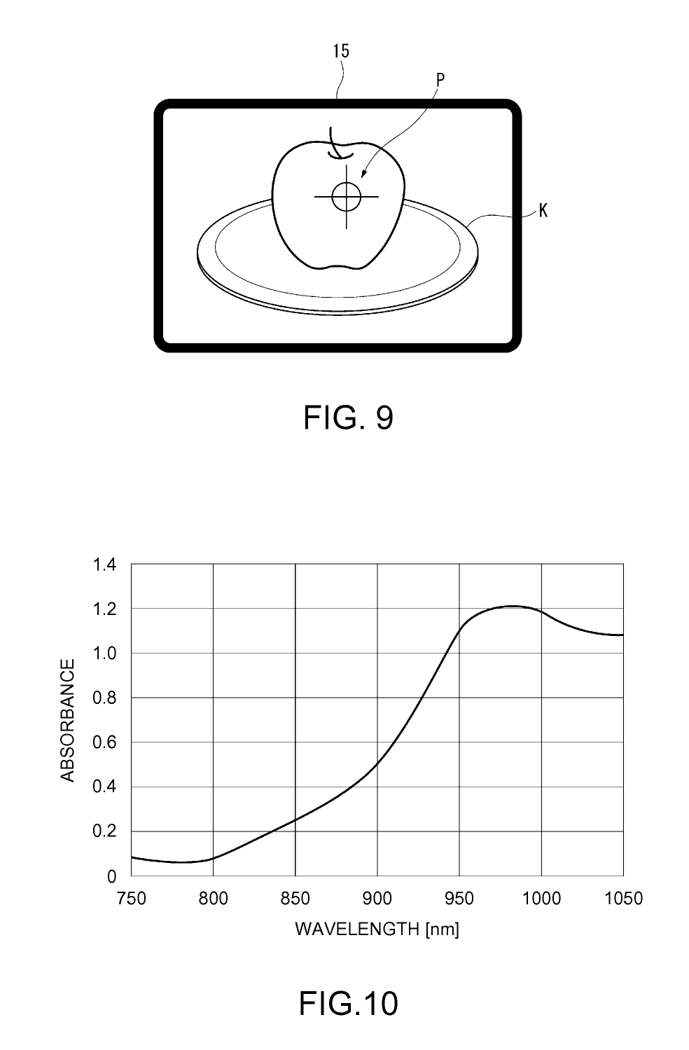

Then, the visible light incident part 121 of the component analyzer 10 is directed toward the test object by the user, and the image acquisition unit 195 takes a color image of the test object. FIG. 9 shows an example of the color image taken when the component analyzer 10 is directed toward the test object. Note that, at this time, it is not necessary to store the taken image as image data in a temporary storage unit or acquire any spectroscopic image of the near-infrared range. Then, the data display unit 199 allows the display 15 to display the image taken by the visible light imaging module 12 in real time as shown in FIG. 9, for example (S3).

Note that, in the embodiment, not only component analysis of the entire test object can be performed, but also a component analysis with respect to a designated point P can be performed, and, in this case, as shown in FIG. 9, the designated point P of the component analysis object is displayed on the display 15.

Further, in this example, the example in which the color image is displayed on the display 15 is shown, however, in the configuration without the visible light imaging module 12, for example, processing of taking a spectroscopic image at a predetermined wavelength in the near-infrared range on the display 15 and displaying it on the display 15 may be performed.

Then, the correction unit 192 detects temperatures at the respective points of the test object from the temperature distribution of the test object detected by the temperature detection sensor 14, and corrects the absorption spectra in the respective components (S4). Specifically, the correction unit 192 multiplies the wavelength at which a feature quantity is detected in the absorption spectrum of the component to be analyzed set at S2 by the correction value of the correction data stored in the storage part 18. For example, when absorbance of a wavelength λ_{A0} changes depending on the content ratio of a component A at a reference temperature T₀, the feature quantity of the component A at the reference temperature T₀ is the absorbance of the wavelength λ_{A0}. However, at a temperature T₁, absorbance of a wavelength λ_{A1} may change depending on the content ratio of the component A, and, in this case, the feature quantity of the component A at the reference temperature T₁ is the absorbance of the wavelength λ_{A1}. Specifically, it is known that water significantly changes in the absorption spectrum as the temperature changes, and it is necessary to correct the wavelength at which the feature quantity is detected for analyses of the respective components.

On the other hand, the correction unit 192 of the embodiment reads out the correction values of the respective components with respect to the respective temperatures stored in the storage part 18, multiplies the wavelength λ_{A0} by the correction value, and calculates the wavelength λ_{A1} at which the feature quantity is detected with respect to the temperature T₁ and uses it as the wavelength to be measured. Further, when the temperature varies depending on the part of the test object, the respective wavelengths to be measured are calculated in response to the temperatures of the respective parts.

Then, the computation part 19 determines whether or not an image taking operation has been performed by the operation of the operation unit 16 by the user such as pressing of the shutter button or the like, for example (S5).

At S5, if the image taking operation has not been performed, processing at S3 and S4 is continued and the operation waits.

On the other hand, if the image taking operation has been performed, imaging processing is performed by the light source drive unit 193, the filter drive unit 194, and the image acquisition unit 195 of the computation part 19 (S6).

In the imaging processing at S6, the light source drive unit 193 outputs a control signal for driving the light source part 132 to the control board 134 of the near-infrared imaging module 13. In this regard, the light source drive unit 193 does not turn on all light sources 132A, but sequentially switch and turn on the light sources 132A corresponding to the wavelengths to be measured set at S4.

For example, when absorbance of the wavelengths λ_{A}, λ_{B} to be measured changes depending on the content ratios of the components A and B, it is only necessary to acquire spectroscopic images of the wavelengths λ_{A}, λ_{B} to be measured or spectroscopic images in the wavelength range of a predetermined range centered at the wavelengths λ_{A}, λ_{B} to be measured. In this case, for example, the light source drive unit 193 turns on the light source 132A of the wavelength λ_{A} to be measured and, after the spectroscopic image is acquired, turns on the light source 132A of the wavelength λ_{B} to be measured.

Note that the processing of turning on the light sources 132A of the wavelengths λ_{A}, λ_{B} to be measured at the same time may be performed. Even in this case, power saving may be also realized compared to the case where all light sources 132A are turned on.

Further, in the embodiment, the example in which the spectroscopic image is acquired only with respect to the wavelength necessary for obtainment of the feature quantity required for the component analysis is shown, however, it is not limited to that. For example, in the near-infrared range, spectroscopic images at intervals of 10 nm may be sequentially acquired. In this case, power saving may be also realized by sequentially switching the light sources 132A in response to the wavelengths of the spectroscopic images to be acquired.

Furthermore, at S6, the filter drive unit 194 sets a drive voltage for setting the wavelength of the light to be extracted by the tunable interference filter 5 based on the V-λ, data stored in the storage part 18, and outputs a control signal to the control board 134. Thereby, the control board 134 applies the set drive voltage to the electrostatic actuator 56 of the tunable interference filter 5, and the light having the wavelength in response to the set voltage is extracted from the tunable interference filter 5.

Here, the filter drive unit 194 sequentially switches the drive voltage in response to the wavelength to be measured set at S4 to apply it to the electrostatic actuator 56 like the light source drive unit 193.

Note that, as described above, in the near-infrared range, the spectroscopic images at intervals of 10 nm may be sequentially acquired and, in this case, the filter drive unit 194 switches the drive voltage applied to the electrostatic actuator 56 at fixed intervals so that the wavelength of the light transmitted through the tunable interference filter 5 may be sequentially switched at a pitch of 10 nm.

Then, at S6, the image acquisition unit 195 sequentially acquires the spectroscopic images taken by the imaging part 133 of the near-infrared imaging module 13 from the time when the shutter button of the operation unit 16 is operated by the user. Specifically, the light source 132A to emit light is switched by the light source drive unit 193, and the spectroscopic image taken by the imaging part 133 after a predetermined time elapses (for example, 10 msec) from the time when the voltage applied to the tunable interference filter 5 is switched by the filter drive unit 194.

Then, the image acquisition unit 195 stores the acquired spectroscopic image in the temporary storage region of the storage part 18.

Note that the image acquisition unit 195 may further acquire a color image taken by the color imaging part 122 of the visible light imaging module 12 and store it in the temporary storage region at the time when the shutter button of the operation unit 16 is operated by the user.

Then, the component analysis unit 196 analyzes the content ratios with respect to the respective components set at S2 based on the obtained plural spectroscopic images (S7).

In the component analysis processing at S7, first, the content ratio analysis unit 196A calculates absorbance A_{λ} of the wavelength λ in each pixel by the following equation (1) based on the reference amount of received light I₀ that has been acquired at S1 and the amount of received light I_{λ} in each pixel of the taken spectroscopic image at the wavelength λ.

A_{λ}=−log(I_{λ}/I₀) (1)

Here, FIG. 10 shows an example of absorbance at the point P in FIG. 9. The content ratio analysis unit 196A calculates the absorbance with respect to each pixel of the acquired spectroscopic images at the respective wavelengths, and acquires an absorption spectrum as shown in FIG. 10.

Note that FIG. 10 shows the absorption spectrum when the spectroscopic images are acquired while the wavelengths to be transmitted through the tunable interference filter 5 are switched with respect to each 10 nm in the range from 750 nm to 1050 nm. On the other hand, processing of acquiring the wavelength to be measured for acquirement of the feature quantity of the component set at S2 or the absorption spectrum within the predetermined wavelength range around the wavelength to be measured may be performed.

Then, the content ratio analysis unit 196A analyzes the content ratios of the respective components based on the calculated absorbance A_{λ} and the correlation data stored in the storage part 18. As an analysis method of the component content ratios, a chemometrics method used in related art may be used. As the chemometrics method, for example, a method of multiple regression analysis, main ingredient regression analysis, partial least squares, or the like may be used. Note that the respective analysis methods using the chemometrics method are technologies used in related art, and the explanation will be omitted here.

Further, the content ratio analysis unit 196A specifies the pixel range in which the test object is reflected from the acquired spectroscopic images and calculates the content ratios of the respective components in the entire test object.

The test object may be specified based on the spectroscopic images obtained by the imaging part 133 or specified based on the color image acquired by the color imaging part 122. As a specification method of the test object, an image processing technology in related art may be used and, for example, the pixel range in which the test object is reflected is specified by edge detection within the image or the like. Note that, in the case where the shape feature value of the test object is stored in the storage part 18, the test object may be specified by analyzing the image based on the shape feature value, or the test object may be specified using any other image processing. Then, the content ratio analysis unit 196A calculates an average value of the content ratios in the respective pixels of the specified test object with respect to each component, and uses it as a component content ratio in the entire test object. Note that, for the component content ratio of the entire test object, plural pixels may be picked up from the pixel range of the specified test object, and the component rates analyzed with respect to the pixels may be averaged.

Then, at S2, whether or not the contents of the respective components and the calories have been set as analysis objects (S8).

At S8, if the component contents and the calories have been set, the mass estimation unit 197 estimates the mass of the test object (S9).

At S9, the mass estimation unit 197 first estimates the volume of the test object based on the taken image. The taken image may be one of the acquired spectroscopic images or the color image being taken.

In the embodiment, as described above, when the component contents and the calories are calculated, the test object is mounted on a dish K (reference material) having a known size and imaged as shown in FIG. 9. Therefore, the mass estimation unit 197 estimates an approximate volume of the test object by comparison between the size of the dish K and the size of the test object.

Note that, in the embodiment, the volume of the test object is estimated with the dish K as the reference material, however, it is not limited to the dish K, for example, processing of estimating the volume may be performed by using a scale or marker as the reference material and imaging the material together with the test object.

Further, the estimation of the volume not limited to using the reference material, and the volume of the test object may be estimated by image processing, for example. For example, processing of obtaining the volume of the test object may be performed by three-dimensional analysis processing using the taken images of the test object taken from different angles.

Furthermore, the mass estimation unit 197 estimates a specific gravity of the test object based on the content ratio of water analyzed at S7. Generally, when a food is set as the test object, the water content ratio is dominant for the specific gravity, and, if the water content ratio is assumed to be the specific gravity, no significant error is caused. Therefore, in the embodiment, the mass estimation unit 197 estimates the analyzed water content ratio as the specific gravity. Then, the mass estimation unit 197 estimates the mass of the test object based on the estimated specific gravity and the volume of the test object that has been obtained.

Then, the content calculation unit 196B calculates the contents of the respective components based on the mass estimated at S9 and the content ratios of the respective components analyzed at S7 (S10). Further, if the calorie analysis is set at S2, the calorie calculation unit 196C calculates the calories of the test object according to equation (2) from the contents of fat, sugar, protein calculated at S10.

calorie(kcal)≈fat content(g)×9+protein content(g)×4+sugar content(g)×4 (2)

Then, after S10, or if the component contents and the calories are not set at S8, i.e., if only the content ratios, freshness, sugar, and the like of the respective components are selected, the data display unit 199 allows the display 15 to display the obtained component analysis result (S11).

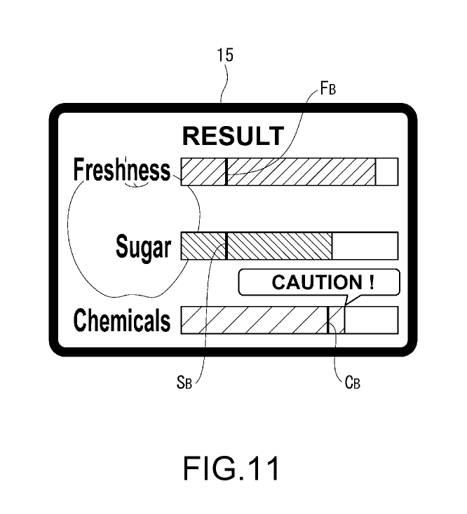

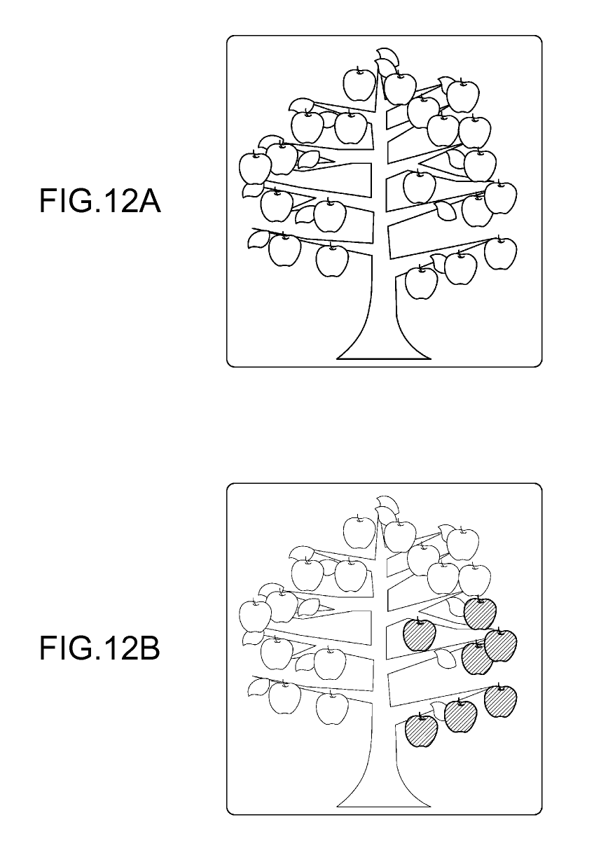

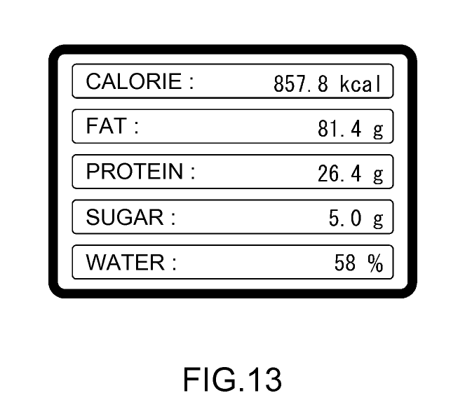

FIG. 11 shows a display example of the display 15 displaying an analysis result of component content ratios. FIGS. 12A and 12B show other display examples of displaying an analysis result of a component content ratio. FIG. 13 shows a display example of the display 15 displaying an analysis result of component contents and calories.

If the content ratios of the respective components are set as analysis objects, the data display unit 199 displays the content ratios of the respective components analyzed at S7. Here, if freshness is selected as the analysis object, the freshness determination unit 198 performs a determination of the freshness from the analysis result of the component corresponding to the type of the test object selected by the user based on the freshness determination data stored in the storage part 18. For example, for fruits and vegetables such as an apple, the freshness may be calculated from the content ratio of chlorophyll.

Further, FIG. 11 shows the example in which freshness (Freshness), sugar (Sugar), and chemical content ratios (Chemicals) are displayed, however, for example, content ratios of various components such as the water content ratio may be displayed within one window.

FIG. 11 shows the example in which the content ratios with respect to the respective components are displayed in a bar chart as the analysis result, however, it is not limited to that. For example, the component content ratios may be displayed in numeric values, a pie chart, or the like. When the content ratios of the respective components are displayed in the bar chart, for example, as shown in FIG. 11, it is preferable to display a line F_{B} indicating a standard sugar content, and lines S_{B}, C_{B} indicating borders of freshness and chemical content ratios.

Further, as the display of the analysis result, only the result with respect to the designated point P may be displayed, or the analysis result of the entire test object may be displayed. Furthermore, it is more preferable that these displays can be appropriately switched.

In addition, in the embodiment, for an analysis of the content ratio of a component with respect to each pixel, a distribution of the content ratio of the component may be displayed as shown in FIGS. 12A and 12B. Here, FIG. 12A shows an example of a color image, and FIG. 12B shows a distribution of sugar content (sugar content ratio). In FIG. 12B, the parts having predetermined or higher values of sugar contents are shown by shaded parts, however, a result window in different sugar contents with different colors may be displayed, for example. As shown in FIGS. 12A and 12B, it becomes possible to easily determine apples having predetermined or higher values of sugar content from the apples on the entire tree. Thereby, for example, when a user engaging in farming gathers harvests, objects to be harvested can be easily determined.

Further, when processing at S10 is performed, the data display unit 199 displays the analysis result as shown in FIG. 13.

Generally, in the case where calories and nutrient contents of cooked foods are obtained, it has been necessary to search for cooked foods to be consumed from a food composition table showing calories and nutrient contents of representative cooked foods, and the dishes shown in the food composition table have been limited to the representative cooked foods. Further, it has been necessary to calculate calories and nutrient contents with respect to creative cooked foods, for example, by people having special knowledge such as dieticians. On the other hand, in the embodiment, component analyses are performed based on the absorbance of the respective components according to spectroscopic images, and thus, the food composition table, special knowledge, or the like is unnecessary and calories and nutrient contents can be easily confirmed regardless of the kinds of cooked foods.

### Advantages of First Embodiment

In the embodiment, the component analyzer 10 includes the casing 11. In the near-infrared imaging window 112 of the casing 11, the light incident part 131 and the light source part 132 are provided, and, within the casing 11, the tunable interference filter 5 that incident light guided by the light incident part 131 enters, the imaging part 133 that receives the light extracted by the tunable interference filter 5 and takes spectroscopic images, and the control unit 17 that performs the component analysis of the test object or the like based on the spectroscopic images are provided.

In the component analyzer 10, the component analysis of the test object is performed based on the spectroscopic images, and thus, it is not necessary to bring the component analyzer 10 into contact with the test object, and breakage of the test object may be prevented. Further, even when the test object is a food, the component analysis may be contactlessly performed, and there is no sanitary concern.

In addition, in the component analysis based on the spectroscopic images, a component analysis with respect to a predetermined point of the test object and a component analysis of a range imaged as the spectroscopic images (for example, the entire test object) may be performed.

Further, in the embodiment, the tunable interference filter 5 is used as a device for extracting light having a predetermined wavelength from incident light. The tunable interference filter 5 is an optical substrate including the fixed substrate 51 provided with the fixed reflection film 54, the movable substrate 52 provided with the movable reflection film 55, and the electrostatic actuator 56 for adjustment of the distance of G1, and its thickness dimension may be made smaller than those of an LCTF, an AOTF, or the like, for example. Therefore, in the component analyzer 10 using the tunable interference filter 5, the analyzer may be made small and thin.

In the embodiment, the movable substrate 52 of the tunable interference filter 5 is fixed to one surface side of the control board 134, and the imaging part 133 is fixed to the other surface side of the control board 134. Further, the light passage hole 134A is provided on the control board 134, and the light transmitted through the tunable interference filter 5 passes through the light passage hole 134A and enters the imaging part 133.

In this configuration, the tunable interference filter 5 and the imaging part 133 may be closely provided. Therefore, compared to the case where the tunable interference filter 5 and the imaging part 133 are provided with a space in between, for example, the near-infrared imaging module 13 and the component analyzer 10 may be made even smaller and thinner. Further, alignment adjustment of the imaging part 133 with respect to the respective reflection films 54, 55 of the tunable interference filter 5 may be accurately performed with reference to the light passage hole 134A of the control board 134.

Furthermore, the tunable interference filter 5 and the imaging part 133 are fixed to the control board 134, and thus, the connection of the tunable interference filter 5 and the control board 134 to the terminal part and the connection of the imaging part 133 and the control board 134 to the terminal part may be easily performed. Further, long leads are not necessary and wiring space is not needed, and the component analyzer 10 and the near-infrared imaging module 13 may be made smaller by omitting the space.

In the embodiment, in the light incident part 131, the telecentric system is formed by plural lenses and the aperture as alight incident angle adjustment unit is provided in the focal position of the telecentric lenses, and the incident angle is limited to 20 degrees or less.

Accordingly, the optical axis of the incident light may be made in parallel to the principal ray and the light may be made to perpendicularly enter the tunable interference filter 5. As such, light having a predetermined wavelength to be measured may be transmitted through the tunable interference filter 5, and the high-accuracy spectroscopic image with respect to the desired wavelength may be acquired. Therefore, accurate component analysis may be performed on predetermined points of the spectroscopic images, and accurate component analysis of the test object may be performed from the analysis results.

In the embodiment, the visible light imaging module 12 is provided, and the color image is taken by the visible light imaging module 12. Further, the data display unit 199 displays the taken color image on the display 15.

Accordingly, the user may easily confirm the component analysis range of the test object by confirming the color image displayed by the display 15.

In the embodiment, the light source part 132 includes the plural light sources 132A having different emission wavelengths. Further, the light source drive unit 193 sequentially drives the light sources 132A when the spectroscopic images are acquired. That is, the light source drive unit 193 drives to turn on the light sources 132A corresponding to the wavelength to be measured for acquisition of the feature quantity of the component to be analyzed.

In the configuration, the desired light sources 132A are driven, and, for example, power saving may be realized compared to the case where all light sources 132A are turned on. Particularly, in the compact portable component analyzer 10 of the embodiment, a mountable battery is restricted and is difficult to supply high power. By realizing power saving in the above described manner, a longer life of the battery may be realized.

In the embodiment, the imaging part 133 includes plural image sensing devices for monochrome imaging.

Accordingly, compared to the configuration in which image sensing devices for color imaging are used as the image sensing devices, i.e., the configuration in which image sensing devices for RGB are respectively provided for each pixel, the light receiving surface per one image sensing device may be made larger and the amount of received light may be made larger. Thereby, the signal values output from the respective image sensing devices by the imaging part 133 become larger and high-accuracy spectroscopic images may be acquired, and a more accurate component analysis may be performed.

The light source part 132 of the embodiment includes the light sources 132A that output visible light. Accordingly, even when the imaging environment is dark, the color image may be taken by the visible light imaging module 12, and the imaging range of the test object may be easily confirmed.

The control unit 17 of the embodiment has correlation data indicating the relationships between the feature quantities with respect to the components to be analyzed and the content ratios of the components. Further, the computation part 19 of the control unit 17 includes the filter drive unit 194 for setting the drive voltage applied to the electrostatic actuator 56 of the tunable interference filter 5 and the component analysis unit 196 for analyzing the component to be analyzed from the spectroscopic image of the wavelength to be measured.

Accordingly, by the control of the filter drive unit 194, light having the wavelength to be measured may be extracted from the tunable interference filter 5, and the spectroscopic image of the wavelength to be measured may be taken by the imaging part 133. Further, the component analysis unit 196 may calculate the absorbance based on the amount of light in the taken spectroscopic image and may easily perform the component analysis based on the absorbance and the correlation data.

In the embodiment, the temperature detection sensor 14 is provided and the correction unit 192 of the control unit 17 corrects the wavelength at which the feature quantity of the absorption spectrum is detected based on the temperature of each part of the test object detected by the temperature detection sensor 14, and sets the corrected wavelength as the wavelength to be measured. Thereby, in the case where the temperature of the test object is different from the reference temperature, even when a temperature distribution exists within the test object, the spectroscopic image corresponding to the wavelength to be measured at which the feature quantity is detected may be acquired. Therefore, the component analysis unit 196 may perform the component analysis with higher accuracy by performing the component analysis based on the spectroscopic image with respect to the corrected wavelength to be measured.

In the embodiment, the test object is a food, and the content ratio analysis unit 196A analyzes the component content ratios of fat, sugar, protein, and water, the content calculation unit 196B calculates the contents of the respective components based on the obtained content ratios and the estimated mass of the test object, and the calorie calculation unit 196C calculates the calories of the test object based on the calculated contents of the respective components.

That is, in the component analyzer 10 of the embodiment, the content ratios and the contents of fat, sugar, protein, and water forming the basis of the health management, and the calories of foods as test objects may be calculated. Further, as described above, the component analyzer 10 has a portable compact size and may be readily carried, and, for example, the calories of the test object may be readily checked in an outside location or the like. Thereby, for example, the analyzer may contribute to health promotion of the user such as improvement of adult diseases and dietary support.

The mass estimation unit 197 of the embodiment estimates the volume from the taken image of the test object, estimates the water content ratio of the test object analyzed by the content ratio analysis unit 196A as the specific gravity, and estimates the mass of the test object based on the volume and the specific gravity.

The mass of the test object is estimated in this manner, and thereby, the contents of the respective components contained in the test object and the calories may be more accurately calculated.

### Second Embodiment

In the first embodiment, as the example of the light incident angle limitation unit, the example in which the telecentric lenses are applied to the lenses forming the visible light incident part 121 and the viewing angle is adjusted by the aperture has been shown. In this case, it is necessary to form the incidence system by combining many telecentric lenses, and the thickness dimension in the light incident part 131 may be increased.

On the other hand, the second embodiment is different from the first embodiment in that the telecentric lenses are not provided as the incidence system, but a viewing angle limiting plate is used as a light incident angle limitation unit instead.

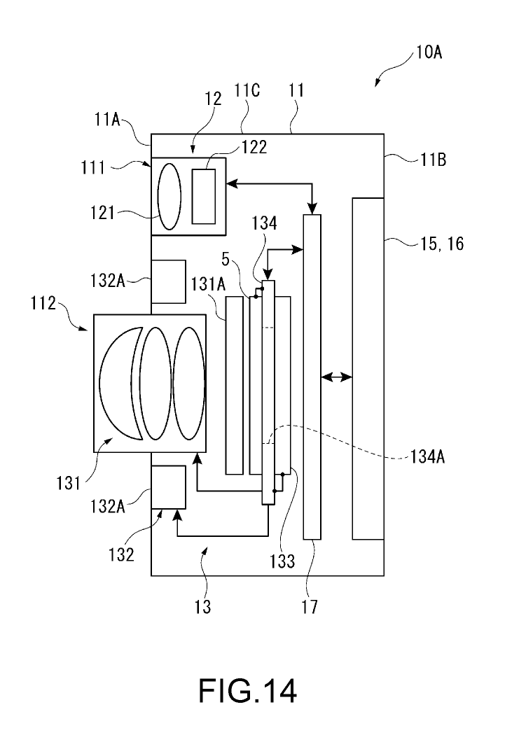

FIG. 14 is a schematic view showing a sectional configuration of a component analyzer in the second embodiment.

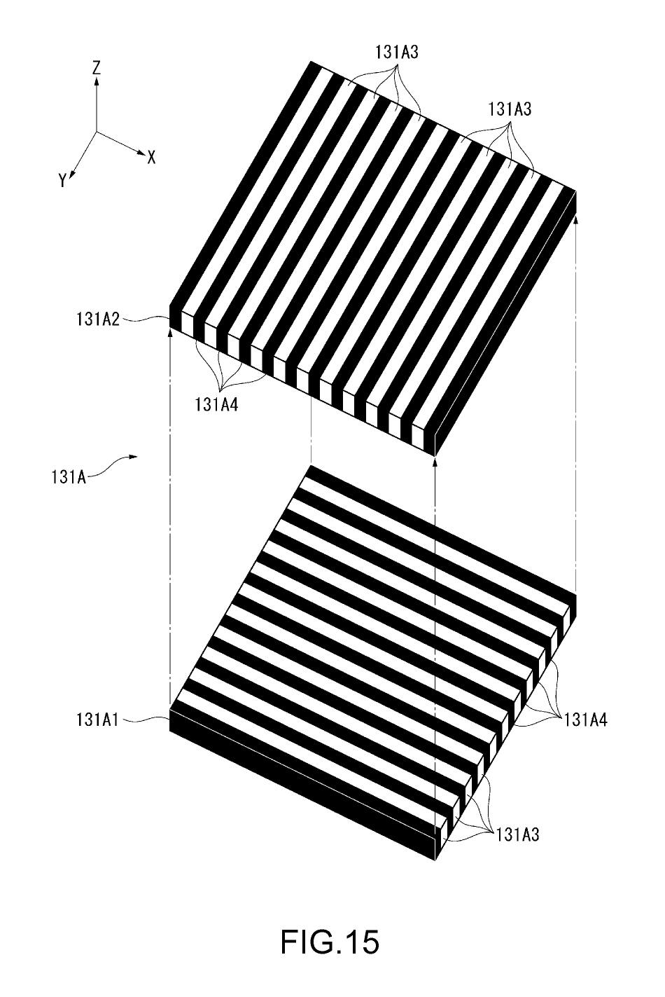

FIG. 15 is a perspective view showing a schematic configuration of the viewing angle limiting plate.

As shown in FIG. 14, the light incident part 131 in the component analyzer 10A of the second embodiment includes plural lenses and the viewing angle limiting plate 131A.

As shown in FIG. 15, the viewing angle limiting plate 131A is formed by combining a first viewing angle limiting plate 131A1 and a second viewing angle limiting plate 131A2 having thickness dimensions along the traveling direction (Z direction) of incident light of predetermined values (for example, about 100 μm to 200 μm).

The first viewing angle limiting plate 131A1 is an optical member in which light transmission parts 131A3 and light blocking parts 131A4 longitudinally extending in the X direction are alternately arranged in the Y direction within a surface orthogonal to the Z direction. The second viewing angle limiting plate 131A2 is an optical member in which the light transmission parts 131A3 and the light blocking parts 131A4 longitudinally extending in the Y direction are alternately arranged in the X direction within a surface orthogonal to the Z direction.

In the viewing angle limiting plate 131A, light at the incident angles to the tunable interference filter 5 equal to or more than a predetermined angle are blocked by the light blocking parts 131A4, and light at the incident angles less than the predetermined angle are transmitted through the light transmission parts 131A3 and enter the tunable interference filter 5.

Note that, the viewing angle limiting plate 131A is not limited to the configuration shown in FIG. 15.

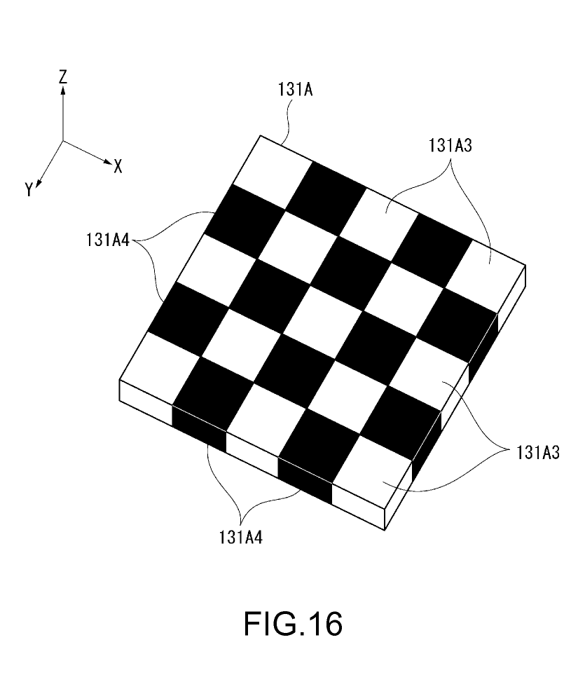

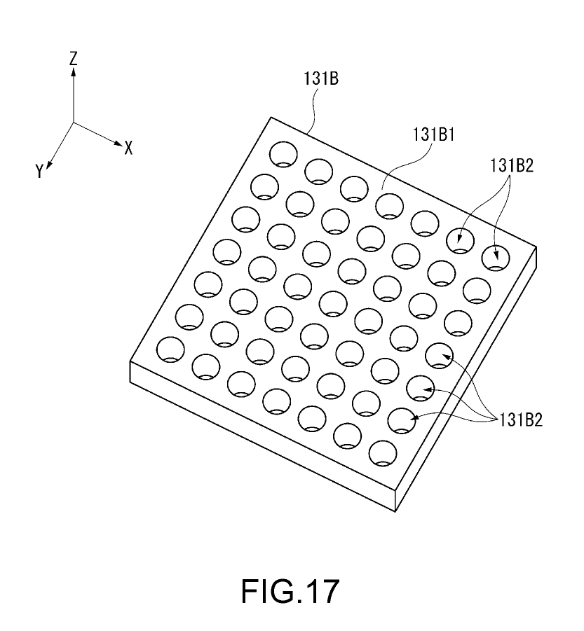

FIGS. 16 and 17 show other examples of the viewing angle limiting plate.

As shown in FIG. 16, the viewing angle limiting plate 131A may have a configuration in which the light transmission parts 131A3 and the light blocking parts 131A4 having thickness dimensions along the traveling direction (Z direction) of incident light of predetermined values (for example, about 100 μm to 200 μm) and square sections orthogonal to the Z direction are alternately arranged in the X direction and the Y direction.

Further, as shown in FIG. 16, plural hole parts 131B2 are formed in a light blocking plate 131B1, and a viewing angle limiting plate 131B that allows the light transmitted through the hole parts 131B2 to enter the tunable interference filter 5 may be formed. In this case, it is preferable to make the respective hole parts 131B2 correspond to the respective image sensing devices of the imaging part 133. Further, a viewing angle limiting plate in which the light blocking parts are formed by cylindrical outer circumferential surfaces and cylinders provided with light transmission parts inside the cylinders are arranged in an array form along the X direction and the Y direction or the like may be used.

### Advantages of Second Embodiment

In the embodiment, the light incident part 131 includes the viewing angle limiting plate 131A. The viewing angle limiting plate 131A includes the first viewing angle limiting plate 131A1 and the second viewing angle limiting plate 131A2 having the predetermined thickness dimensions along the direction orthogonal to the fixed substrate 51 and the movable substrate 52, i.e., the light traveling direction (Z direction). Further, in the first viewing angle limiting plate 131A1, the plural light transmission parts 131A3 and light blocking parts 131A4 longitudinally extending in the X direction are alternately arranged in the Y direction, and, in the second viewing angle limiting plate 131A2, the light transmission parts 131A3 and the light blocking parts 131A4 longitudinally extending in the Y direction are alternately arranged in the X direction.

In the configuration, the light at incident angles equal to or more than the predetermined angle may be blocked by the light blocking parts 131A4, and thus, the angles of the incident light from the test object may be limited to the angles less than the predetermined angle like in the first embodiment. Further, compared to the configuration of limiting the light incident angle using the telecentric lenses, the thickness dimension of the light incident part 131 may be made smaller, and the near-infrared imaging module 13 and the component analyzer 10 may be made even smaller and thinner.

### Third Embodiment

Next, a third embodiment according to the invention will be explained below.

In the above described first embodiment, the mass estimation unit 197 estimates the specific gravity of the test object based on the water content ratio analyzed by the content ratio analysis unit 196A, and estimates the mass of the test object based on the estimated specific gravity and the estimated volume.

On the other hand, the third embodiment is different from the first embodiment in that the mass estimation unit 197 does not perform estimation of the specific gravity.

Note that the third embodiment has the same configuration as that of the first embodiment, and will be explained using the drawings that has been used for the first embodiment.

In the case where the test object is a food, it is known that its specific gravity takes a nearly constant value. Therefore, in the embodiment, the mass estimation unit 197 estimates the mass of the test object using the preset specific gravity and the estimated volume.

Note that, for example, table data in which general values of specific gravities with respect to types of test object may be stored in the storage part 18, and the specific gravity may be estimated based on the type of the test object designated by the user and the table data.

In the embodiment, the mass estimation unit 197 estimates the volume from the taken image of the test object, and calculates the mass of the test object based on the preset specific gravity.

In the processing, compared to the first embodiment, the error of the calculated mass becomes greater, however, the calculation of the contents of the respective components and the calculation of the calories may be performed by the simpler processing, and power consumption due to processing load may be reduced.

### Fourth Embodiment

Next, a fourth embodiment according to the invention will be explained below.

In the above described first embodiment, the mass of the test object is estimated by the mass estimation unit 197 and the contents of the respective components and the calories are calculated based on the estimated mass and the analyzed content ratios of the respective components.

On the other hand, the fourth embodiment is different from the first embodiment in that the mass of test object is measured and the contents of the respective components and the calories are calculated based on the measured mass and the content ratios of the respective components.

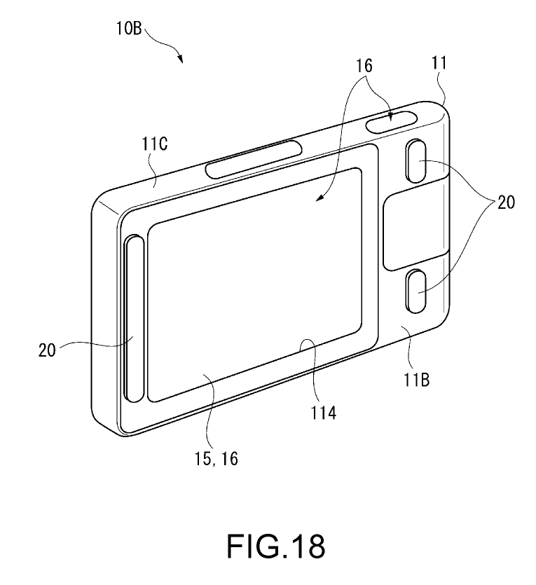

FIG. 18 is a perspective view showing a schematic configuration of a rear surface 11B of a component analyzer 10B of the fourth embodiment.

The component analyzer 10B of the embodiment includes a mass measurement part 20 on the rear surface 11B. Note that the location where the mass measurement part 20 is placed may be provided around the display 15 of the rear surface 11B as shown in FIG. 18, or may be provided on the front surface 11A.

Here, in order to prevent contact with the display 15, it is preferable to employ a configuration in which a concave part is provided on the rear surface 11B and the display window 114 is provided within the concave part, a configuration in which a convex part is provided on the rear surface 11B and the mass measurement part 20 is provided in the convex part, or the like.

Further, the mass measurement part 20 is a sensor for mass measurement of measuring the mass of the test object when the test object is mounted thereon, and can measure the accurate mass of the test object.

In the embodiment, the mass estimation unit 197 in the first embodiment is unnecessary. Therefore, the processing at S9 in the first embodiment is omitted and, in the processing at S10, the content calculation unit 196B calculates the contents of the respective components based on the content ratios of the respective component analyzed by the content ratio analysis unit 196A and the mass of the test object measured by the mass measurement part 20.

### Advantages of Fourth Embodiment

In the component analyzer 10B of the embodiment, the mass measurement part 20 is provided on the rear surface 11B of the casing 11, and the mass of the test object may be directly measured.

Accordingly, an accurate mass of the test object may be measured, and the content calculation unit 196B may calculate the accurate contents of the respective components based on the accurate mass of the test object, and the calorie calculation unit 196C may more accurately calculate the calories of the test object. Thereby, the component analyzer 10B may display the high-accuracy component analysis result on the display 15.

Further, in the embodiment, the mass estimation unit 197 is unnecessary, and the volume estimation processing, the specific gravity processing, and the mass estimation processing by the mass estimation unit 197 are unnecessary. Specifically, in the volume estimation by the mass estimation unit 197, the volume is estimated by image processing of the taken image, however, in the case where the image processing is performed, the processing load may be increased and the battery consumption may be increased depending on the algorithm of the image processing or the like. On the other hand, in the fourth embodiment, various computation following the mass estimation becomes unnecessary, and the processing load may be reduced and the power saving may be realized.

### Other Embodiments

Note that the invention is not limited to the above described embodiments, but includes modifications, improvements, and the like within the range that can achieve the purpose of the invention.

For example, in the respective embodiments, the example in which the component analyzer 10 (10A, 10B) includes the visible light imaging module 12 and the color image is taken by the visible light imaging module 12 has been shown. On the other hand, a configuration without the visible light imaging module 12 may be employed. In this case, the display 15 may be allowed to display a spectroscopic image taken by the near-infrared imaging module 13.

Further, the tunable interference filter 5 may have a configuration that can spectroscopically separate light having a predetermined wavelength from the visible light range to the near-infrared range, and a color image may be taken by the near-infrared imaging module 13 in place of the visible light imaging module 12.

Furthermore, in the embodiments, the component analysis on the component having the feature quantity with respect to the near-infrared range has been performed, however, by a configuration that can spectroscopically separate light from the visible light range to the near-infrared range using the tunable interference filter 5, an analysis of a component having a feature quantity with respect to the visible light range may be also performed. Similarly, the tunable interference filter 5 may have a configuration that can spectroscopically separate light in an ultraviolet range, and, in this case, an analysis of a component having a feature quantity with respect to the ultraviolet range, detection of a material that reacts with ultraviolet light, an analysis of a distribution state of the material, and the like may be further performed.

In addition, the test object has been set to a food, however, it is not limited to that and may be another material. In this case, it is preferable to set the wavelength of the spectroscopic image taken by the near-infrared imaging module 13 in response to the test object desired to be tested and the component to be analyzed.

In the first embodiment, the configuration in which the control board 134 intervenes between the tunable interference filter 5 and the imaging part 133 has been exemplified, however, a configuration in which the imaging part 133 is directly fixed to the light exit surface of the tunable interference filter 5 may be employed. Further, a configuration in which the tunable interference filter 5 and the imaging part 133 are respectively fixed directly or indirectly to a fixing piece provided within the casing 11 or the like may be employed. In this case, for example, it is preferable to closely arrange the tunable interference filter 5 and the imaging part 133 such that the tunable interference filter 5 and the imaging part 133 are fixed in contact with each other.

Further, the configuration is not limited to a case in which the tunable interference filter 5 is singly housed within the casing 11 and, for example, a configuration in which the tunable interference filter 5 is housed within an optical package provided with a light passage hole and the optical package is housed within the casing 11 may be employed. Also, in this case, by providing terminal parts connected to the fixed electrode pad 563P and the movable electrode pad 564P of the tunable interference filter 5 on the outer surface of the optical package, a voltage may be applied to the electrostatic actuator 56 provided in the tunable interference filter 5 within the optical package.

Furthermore, the example in which the tunable interference filter 5 and the imaging part 133 are fixed to the control board 134 has been shown, however, they may be fixed to another substrate or the like.

The tunable interference filter 5 is not limited to the configuration including the electrostatic actuator 56 that changes the amount of gap of the gap between reflection films G1 by voltage application.

For example, a configuration using a dielectric actuator in which a first dielectric coil is provided in place of the fixed electrode 561 and a second dielectric coil or a permanent magnet is provided in place of the movable electrode 562 may be employed.

In addition, a configuration using a piezoelectric actuator in place of the electrostatic actuator 56 may be employed. In this case, for example, a lower electrode layer, a piezoelectric film, and an upper electrode layer are stacked in the holding part 522 and the voltage applied between the lower electrode layer and the upper electrode layer is varied as an input value, and thereby, the piezoelectric film is expanded and contracted to bend the holding part 522.

Further, in the embodiments, the tunable interference filter is not limited to the configuration in which the fixed substrate 51 and the movable substrate 52 are bonded oppositely to each other, the fixed reflection film 54 is provided on the fixed substrate 51 and the movable reflection film 55 is provided on the movable substrate 52.

That is, in the embodiments, one example of the Fabry-Perot etalon as the tunable interference filter has been exemplified, however, it is not limited to the configuration. For example, a configuration in which the fixed substrate 51 and the movable substrate 52 are not bonded and a gap changing part that changes the gap between reflection films such as a piezoelectric element is provided between the substrates may be employed.

Furthermore, the configuration is not limited to the configuration including two substrates. For example, a tunable interference filter in which two reflection films are stacked on one substrate via a sacrifice layer and a gap is formed by removing the sacrifice layer by etching or the like may be used.

In addition, in the embodiments, the portable compact component analyzers 10, 10A, 10B have been exemplified, however, for example, a configuration in which the component analyzer of the embodiment of the invention is mounted on a portable terminal apparatus such as a cellular phone or smartphone may be employed.

Further, the component analyzers 10, 10A, 10B may have configurations that can communicate with a server via the Internet or the like and, in this case, a configuration in which the correlation data stored in the storage part 18 is acquired from a storage unit of the server may be employed. As described above, in the case where the component analyzer of the embodiment of the invention is mounted on a portable terminal apparatus, communication with the server may be made using a communication unit of the portable terminal apparatus.

By employing the configurations that can communicate with a server, the calories and the component contents of foods transmitted from the compact component analyzers 10, 10A, 10B may be transmitted to a server provided in a medical institution or the like. In this case, for example, a medical expert such as a doctor may perform health management of a user or provides healthcare instructions and information to the user, and the use may be further increased.

In addition, acceleration sensors and gyro sensors may be contained in the compact component analyzers 10, 10A, 10B and, in the configurations, for example, the amount of activity and the calorie consumption of the user may be calculated. In this case, calories-in and calories-out of the user are controlled at the same time, and thereby, the health promotion activity of the user may be more efficiently supported.

In the embodiments, plural light sources 132A having different emission wavelengths have been provided as the light sources 132A forming the light source part 132, and the light source drive unit 193 has sequentially driven the light sources 132A in response to the wavelength to be measured. On the other hand, as the light source part 132, one or plural light sources that can cover a wider wavelength range of the infrared range may be provided. In this case, the light source drive unit 193 is not necessary to sequentially switch and drive the light sources, and thereby, processing may be simplified.

Further, a configuration without any visible light source in the light source part 132 may be employed. Also, in this case, if the outdoor light is sufficient, the color image of the test object may be displayed on the display 15. If the outdoor light is insufficient, the spectroscopic image in the near-infrared range may be displayed on the display 15 using a light source of near-infrared light, for example.

In the embodiments, the temperature detection sensor 14 has been provided and the correction unit 192 has corrected the wavelength at which the feature quantity of the component to be analyzed can be acquired based on the detected temperature, and sets it as the wavelength to be measured.

On the other hand, a configuration without the temperature detection sensor 14 may be employed. Also, in this case, a less erroneous component analysis may be performed on the component with a little change in absorption spectrum due to the temperature.

The other specific structure when the invention is implemented may be appropriately changed to other structures or the like in a range that can achieve the purpose of the invention.

The entire disclosure of Japanese Patent Application No. 2012-047230 filed Mar. 2, 2012 is expressly incorporated by reference herein.

What is claimed is:

1. A component analyzer comprising:
a casing;
a light source that is provided within the casing and outputs light to a test object;
a light guide that guides light reflected by the test object into the casing;
a tunable interference filter that is provided within the casing and extracts light having a predetermined wavelength from the light received from the light guide;
an imager that is provided within the casing, receives the light extracted by the tunable interference filter, and takes a spectroscopic image; and
a controller that is provided within the casing and performs a component analysis of the test object based on the spectroscopic image,
wherein the tunable interference filter is a Fabry-Perot etalon.

2. The component analyzer according to claim 1, wherein the light guide includes:
plural lens groups that form a virtual image of the test object in the imager, and
a light incident angle adjuster that limits the incident light to a predetermined angle or less.

3. The component analyzer according to claim 2, wherein the light incident angle adjuster has plural light transmission parts and plural light blocking parts having predetermined thickness dimensions along a light incident direction orthogonal to a light incident surface of the tunable interference filter, and includes a viewing angle limiting plate in which the light transmission parts and the light blocking parts are alternately and adjacently arranged within a surface orthogonal to the light incident direction.

4. The component analyzer according to claim 1, wherein the imager is provided on a light exit surface of the tunable interference filter.

5. The component analyzer according to claim 1, wherein the tunable interference filter extracts light having a predetermined wavelength in at least one of a visible light range and a near-infrared range.

6. The component analyzer according to claim 1, further comprising:
a color imager that is provided within the casing, and receives a light in a visible light range from the light reflected by the test object and takes a color image;
a color image guide that guides the light to the color imager; and
a display that displays the color image taken by the color imaging unit.

7. The component analyzer according to claim 1, wherein the imager has image sensing devices for monochrome imaging.

8. The component analyzer according to claim 1, wherein the light source includes plural light sources that output light having different wavelengths, and
the controller turns on the light source that outputs a light having a wavelength corresponding to a component to be analyzed.

9. The component analyzer according to claim 1, wherein the light source includes a visible light source that outputs a visible light.

10. The component analyzer according to claim 1, wherein the controller includes:
a storage part that stores correlation data between feature quantities extracted from absorption spectra of components to be analyzed and component content ratios of components to be analyzed;
a filter that sets the wavelength of the light to be extracted by the tunable interference filter; and
a component analysis part that analyzes a content ratio and a content of the component to be analyzed of the test object based on an amount of light of respective pixels in the spectroscopic image and the correlation data.

11. The component analyzer according to claim 10, further comprising a temperature detection sensor that detects a temperature of the test object,
wherein the controller includes a corrector that corrects the absorption spectrum of each component based on the detected temperature.

12. The component analyzer according to claim 10, wherein the test object is food, and
the component analysis part analyzes a content ratio and a content of one component of fat, sugar, protein, and water contained in the test object and calculates calories of the test object.

13. The component analyzer according to claim 12, further comprising a mass measurer that measures a mass when the test object is mounted thereon,
wherein the component analysis part calculates a content of the component to be analyzed in the test object from the content ratio of the component to be analyzed contained in the test object and the measured mass of the test object.

14. The component analyzer according to claim 12, wherein the controller includes amass estimator that estimates a volume of the test object from a taken image of the test object, estimates a specific gravity of the test object based on the content ratio with respect to the predetermined component analyzed by the component analysis part, and calculates the mass of the test object from the estimated volume and specific gravity, and
the component analysis part calculates a content of the component to be analyzed in the test object from the content ratio of the component to be analyzed contained in the test object and the estimated mass of the test object.

15. The component analyzer according to claim 12, wherein the controller includes amass estimator that estimates a volume of the test object from a taken image of the test object, and calculates the mass of the test object from a preset specific gravity and the estimated volume, and
the component analysis part calculates a content of the component to be analyzed in the test object from the content ratio of the component to be analyzed of the test object and the estimated mass of the test object.

16. The component analyzer according to claim 14, wherein the mass estimator estimates the volume of the test object based on a taken image formed by imaging a reference material having a known size together with the test object.
